(19) United States
(12) Patent Application Publication
(10) Pub. No.: US 2025/0179622 A1
(43) Pub. Date: Jun. 5, 2025

(54) DEHYDROGENATION APPARATUS, STEEL SHEET PRODUCTION SYSTEM, AND METHOD OF PRODUCING STEEL SHEET

(71) Applicant: JFE STEEL CORPORATION, Chiyoda-ku, Tokyo (JP)

(72) Inventors: Kazuki ENDOH, Chiyoda-ku, Tokyo (JP); Ryohei MORIMOTO, Chiyoda-ku, Tokyo (JP); Yuki TOJI, Chiyoda-ku, Tokyo (JP)

(73) Assignee: JFE STEEL CORPORATION, Chiyoda-ku, Tokyo (JP)

(21) Appl. No.: 18/844,196

(22) PCT Filed: Mar. 1, 2023
(86) PCT No.: PCT/JP2023/007691

§ 371 Date: Sep. 5, 2024

(30) Foreign Application Priority Data
Mar. 25, 2022 (JP) 2022-050837

(51) Int. Cl. C23C 2/40; C22C 38/00; C22C 38/02; C22C 38/04; C22C 38/06; C22C 38/08; C22C 38/12; C22C 38/14; C22C 38/16; C22C 38/38; C22C 38/60; C23C 2/28

(52) U.S. Cl. CPC C23C 2/40; C22C 38/001; C22C 38/002; C22C 38/005; C22C 38/008; C22C 38/02; C22C 38/04; C22C 38/06; C22C 38/08; C22C 38/12; C22C 38/14; C22C 38/16; C22C 38/38; C22C 38/60; C23C 2/285

(57) ABSTRACT

Provided are a dehydrogenation apparatus, a steel sheet production system, and a method of producing a steel sheet capable of producing a steel sheet having excellent hydrogen embrittlement resistance without changing mechanical properties of the steel sheet. The dehydrogenation apparatus includes a housing that accommodates a steel sheet coil of a steel strip coiled into a coil shape, and a magnetic field applying apparatus that applies a steady magnetic field along the sheet transverse direction of the steel sheet coil in the housing.

### TECHNICAL FIELD

The present disclosure relates to a dehydrogenation apparatus, a steel sheet production system, and a method of producing a steel sheet for producing a steel sheet suitable for use as a member in industrial fields such as automobiles, home appliances, and construction materials. In particular, the present disclosure relates to a dehydrogenation apparatus, a steel sheet production system, and a method of producing a steel sheet for producing a steel sheet having low diffusible hydrogen content in the steel and excellent hydrogen embrittlement resistance.

### BACKGROUND

As a concern specific to high strength steel sheets, it is known that hydrogen entering a steel sheet embrittles the steel sheet (hydrogen embrittlement). Steel sheets are typically annealed in a reducing atmosphere containing hydrogen, and therefore diffusible hydrogen enters the steel during annealing. Unless diffusible hydrogen that has entered steel is sufficiently decreased, diffusible hydrogen content may cause hydrogen embrittlement and delayed fracture in a steel sheet.

Accordingly, methods to decrease diffusible hydrogen in steel that entered during annealing have been studied. A known method to decrease diffusible hydrogen content in steel is to leave a steel sheet after annealing at room temperature for an extended period of time to desorb diffusible hydrogen from a surface of the steel sheet. Further, Patent Literature (PTL) 1 describes a method of decreasing diffusible hydrogen content in steel by holding a steel sheet annealed after cold rolling in a temperature range of 50° C. or more and 300° C. or less for 1800 s or more to 43,200 s or less.

### CITATION LIST

### Patent Literature

PTL 1: WO 2019/188642 A1

### SUMMARY

### Technical Problem

Using the method of leaving a steel sheet at room temperature, leaving the steel sheet for a long time is required, and productivity is low. Further, regarding PTL 1, there are concerns about changes in mechanical properties such as increased yield stress and tempering embrittlement due to microstructural changes caused by heating.

In view of the circumstances, it would be helpful to provide a steel sheet dehydrogenation apparatus, a steel sheet production system, and a method of producing a steel sheet capable of producing a steel sheet having excellent hydrogen embrittlement resistance without changing mechanical properties of the steel sheet.

### Solution to Problem

The inventors have made extensive studies and found that when a steady magnetic field is applied along the sheet transverse direction of a steel sheet, diffusible hydrogen content in the steel may be decreased and hydrogen embrittlement may be suppressed. This is presumably due to the following mechanisms. Applying a steady magnetic field to a steel sheet changes the form of the steel sheet due to the magnetostriction effect. The steady magnetic field applied to the steel sheet is along the sheet transverse direction, and therefore lattice spacing of the steel sheet expands along a main surface (front and back) direction of the steel sheet, along the sheet transverse direction. As a result, hydrogen in the steel sheet diffuses toward the main surfaces (front and back) of the steel sheet, where potential energy is low, and desorbs from the main surfaces.

The present disclosure is based on the aforementioned discoveries. Primary features of the present disclosure are as follows.

[1]A dehydrogenation apparatus comprising:
a housing configured to accommodate a steel sheet coil obtained by coiling a steel strip; and
a magnetic field applying apparatus configured to apply a steady magnetic field along the sheet transverse direction of the steel sheet coil in the housing.

[2] The dehydrogenation apparatus according to [1], above, wherein the magnetic field applying apparatus comprises an electromagnet disposed outside a sheet transverse direction edge of the steel sheet coil, and the electromagnet has a magnetic pole face facing a sheet transverse direction end surface of the steel sheet coil.

[3] The dehydrogenation apparatus according to [1] or [2], above, wherein the magnetic field applying apparatus comprises a pair of electromagnets disposed outside sheet transverse direction edges of the steel sheet coil, and each electromagnet of the pair of electromagnets has a magnetic pole face facing a sheet transverse direction end surface of the steel sheet coil, and one of the magnetic pole faces is an N pole and the other is an S pole.

[4] The dehydrogenation apparatus according to any one of [1] to [3], above, wherein the magnetic field applying apparatus is set so that magnetic flux density in the sheet transverse direction of the steel sheet coil is 0.1 T to 15 T.

[5] The dehydrogenation apparatus according to any one of [1] to [4], above, further comprising a heater configured to heat the steel sheet coil while the steady magnetic field is being applied.

[6]A dehydrogenation apparatus comprising:
a payoff apparatus configured to uncoil a steel sheet coil to feed a steel strip;
a sheet passing apparatus configured to pass the steel strip therethrough;
a coiling apparatus configured to coil the steel strip;
a magnetic field applying apparatus configured to apply a steady magnetic field along the sheet transverse direction of the steel strip to the steel strip being passed through the sheet passing apparatus.

[7] The dehydrogenation apparatus according to [6], above, wherein the magnetic field applying apparatus comprises an electromagnet disposed outside a sheet transverse direction edge of the steel strip, and the electromagnet has a magnetic pole face facing a sheet transverse direction edge surface of the steel strip.

[8] The dehydrogenation apparatus according to [6] or [7], above, wherein the magnetic field applying apparatus comprises a pair of electromagnets disposed outside sheet transverse direction edges of the steel strip, and each electromagnet of the pair of electromagnets has a magnetic pole face facing a sheet transverse direction edge surface of the steel strip, and one of the magnetic pole faces is an N pole and the other is an S pole.

[9] The dehydrogenation apparatus according to any one of [6] to [8], above, wherein the magnetic field applying apparatus is set so that magnetic flux density in the sheet transverse direction of the steel strip is 0.1 T to 15 T.

[10] The dehydrogenation apparatus according to any one of [6] to [9], above, further comprising a heater configured to heat the steel strip while the steady magnetic field is being applied.

[11] The dehydrogenation apparatus according to any one of [1] to [10], above, further comprising a magnetic field blocker configured to prevent transmission of the steady magnetic field to outside of the dehydrogenation apparatus.

[12]A steel sheet production system comprising:
a hot rolling apparatus configured to hot roll a steel slab to obtain a hot-rolled steel sheet;
a hot-rolled steel sheet coiling apparatus configured to coil the hot-rolled steel sheet to obtain a hot-rolled coil; and
the dehydrogenation apparatus according to any one of [1] to [11], above, wherein the hot-rolled coil is the steel sheet coil.

[13]A steel sheet production system comprising:
a cold rolling apparatus configured to cold roll a hot-rolled steel sheet to obtain a cold-rolled steel sheet;
a cold-rolled steel sheet coiling apparatus configured to coil the cold-rolled steel sheet to obtain a cold-rolled coil; and
the dehydrogenation apparatus according to any one of [1] to [11], above, wherein the cold-rolled coil is the steel sheet coil.

[14]A steel sheet production system comprising:
a batch annealing furnace configured to batch anneal a cold-rolled coil or a hot-rolled coil to obtain an annealed coil; and
the dehydrogenation apparatus according to any one of [1] to [11], above, wherein the annealed coil is the steel sheet coil.

[15]A steel sheet production system comprising:
a pre-annealing payoff apparatus configured to uncoil a cold-rolled coil or a hot-rolled coil to feed a cold-rolled steel sheet or a hot-rolled steel sheet, respectively;
a continuous annealing furnace configured to continuously anneal the cold-rolled steel sheet or the hot-rolled steel sheet to obtain an annealed steel sheet;
an annealed steel sheet coiling apparatus configured to coil the annealed steel sheet to obtain an annealed coil; and
the dehydrogenation apparatus according to any one of [1] to [11], above, wherein the annealed coil is the steel sheet coil.

[16]A steel sheet production system comprising:
a coating or plating apparatus configured to form a coating or plating on a surface of a hot-rolled steel sheet or a cold-rolled steel sheet to obtain a coated or plated steel sheet;
a coated or plated steel sheet coiling apparatus configured to coil the coated or plated steel sheet to obtain a coated or plated steel sheet coil; and
the dehydrogenation apparatus according to any one of [1] to [11], above, wherein the coated or plated steel sheet coil is the steel sheet coil.

[17] The steel sheet production system according to [16], above, wherein the coating or plating apparatus is a hot-dip galvanizing apparatus.

[18] The steel sheet production system according to [16], above, wherein the coating or plating apparatus comprises a hot-dip galvanizing apparatus and a subsequent alloying furnace.

[19] The steel sheet production system according to [16], above, wherein the coating or plating apparatus is an electroplating apparatus.

[20]A method of producing a steel sheet, the method comprising:
a magnetic field applying process of applying a steady magnetic field to a steel sheet coil obtained by coiling a steel strip, along the sheet transverse direction of the steel sheet coil, to obtain a product coil.

[21] The method of producing a steel sheet according to [20], above, wherein magnetic flux density in the sheet transverse direction of the steel sheet coil is 0.1 T to 15 T in the magnetic field applying process.

[22] The method of producing a steel sheet according to [20] or [21], above, wherein the magnetic field applying process is performed while holding the steel sheet coil at 300° C. or less.

[23]A method of producing a steel sheet, the method comprising:
a process of uncoiling a steel sheet coil to feed a steel strip;
a sheet passing process of passing the steel strip; and
a process of coiling the steel strip to obtain a product coil,
wherein the sheet passing process includes a magnetic field applying process of applying a steady magnetic field to the steel strip along the sheet transverse direction of the steel strip.

[24] The method of producing a steel sheet according to [23], above, wherein magnetic flux density in the sheet transverse direction of the steel strip is 0.1 T to 15 T in the magnetic field applying process.

[25] The method of producing a steel sheet according to [23] or [24], above, wherein the magnetic field applying process is performed while holding the steel strip at 300° C. or less.

[26] The method of producing a steel sheet according to any one of [20] to [25], above, the method further comprising:
a process of hot rolling a steel slab to obtain a hot-rolled steel sheet; and
a process of coiling the hot-rolled steel sheet to obtain a hot-rolled coil,
wherein the hot-rolled coil is the steel sheet coil.

[27] The method of producing a steel sheet according to any one of [20] to [25], above, the method further comprising:
a process of cold rolling a hot-rolled steel sheet to obtain a cold-rolled steel sheet; and
a process of coiling the cold-rolled steel sheet to obtain a cold-rolled coil,
wherein the cold-rolled coil is the steel sheet coil.

[28] The method of producing a steel sheet according to any one of [20] to [25], above, the method further comprising a process of batch annealing a cold-rolled coil or a hot-rolled coil to obtain an annealed coil, wherein the annealed coil is the steel sheet coil.

[29] The method of producing a steel sheet according to any one of [20] to [25], above, the method further comprising:
a process of uncoiling a cold-rolled coil or a hot-rolled coil to feed a cold-rolled steel sheet or a hot-rolled steel sheet, respectively;
a process of continuously annealing the cold-rolled steel sheet or the hot-rolled steel sheet to obtain an annealed steel sheet; and
a process of coiling the annealed steel sheet to obtain an annealed coil,
wherein the annealed coil is the steel sheet coil.

[30] The method of producing a steel sheet according to any one of [20] to [25], above, the method further comprising:
a coating or plating process of forming a coating or plating on a surface of a hot-rolled steel sheet or a cold-rolled steel sheet to obtain a coated or plated steel sheet; and
a process of coiling the coated or plated steel sheet to obtain a coated or plated steel sheet coil,
wherein the coated or plated steel sheet coil is the steel sheet coil.

[31] The method of producing a steel sheet according to [30], above, wherein the coating or plating process comprises a hot-dip galvanizing process.

[32] The method of producing a steel sheet according to [30], above, wherein the coating or plating process comprises a hot-dip galvanizing process and a subsequent alloying process.

[33] The method of producing a steel sheet according to [30], above, wherein the coating or plating process comprises an electroplating process.

[34] The method of producing a steel sheet according to any one of [20] to [33], above, wherein the product coil comprises a high strength steel sheet having a tensile strength of 590 MPa or more.

[35] The method of producing a steel sheet according to any one of [20] to [34], above, wherein the product coil comprises a base steel sheet having a chemical composition containing (consisting of), in mass %,
C: 0.030% or more and 0.800% or less,
Si: 0.01% or more and 3.00% or less,
Mn: 0.01% or more and 10.00% or less,
P: 0.001% or more and 0.100% or less,
S: 0.0001% or more and 0.0200% or less,
N: 0.0005% or more and 0.0100% or less, and
Al: 2.000% or less,
with the balance being Fe and inevitable impurity.

[36] The method of producing a steel sheet according to [35], above, wherein the chemical composition further contains, in mass %, at least one element selected from the group consisting of
Ti: 0.200% or less,
Nb: 0.200% or less,
V: 0.500% or less,
W: 0.500% or less,
B: 0.0050% or less,
Ni: 1.000% or less,
Cr: 1.000% or less,
Mo: 1.000% or less,
Cu: 1.000% or less,
Sn: 0.200% or less,
Sb: 0.200% or less,
Ta: 0.100% or less,
Ca: 0.0050% or less,
Mg: 0.0050% or less,
Zr: 0.0050% or less, and
REM: 0.0050% or less.

[37] The method of producing a steel sheet according to any one of [20] to [34], above, wherein the product coil comprises a stainless steel sheet having a chemical composition containing (consisting of), in mass %,
C: 0.001% or more and 0.400% or less,
Si: 0.01% or more and 2.00% or less,
Mn: 0.01% or more and 5.00% or less,
P: 0.001% or more and 0.100% or less,
S: 0.0001% or more and 0.0200% or less,
Cr: 9.0% or more and 28.0% or less,
Ni: 0.01% or more and 40.0% or less,
N: 0.0005% or more and 0.500% or less, and
Al: 3.000% or less,
with the balance being Fe and inevitable impurity.

[38] The method of producing a steel sheet according to [37], above, wherein the chemical composition further contains, in mass %, at least one element selected from the group consisting of
Ti: 0.500% or less,
Nb: 0.500% or less,
V: 0.500% or less,
W: 2.000% or less,
B: 0.0050% or less,
Mo: 2.000% or less,
Cu: 3.000% or less,
Sn: 0.500% or less,
Sb: 0.200% or less,
Ta: 0.100% or less,
Ca: 0.0050% or less,
Mg: 0.0050% or less,
Zr: 0.0050% or less, and
REM: 0.0050% or less.

[39] The method of producing a steel sheet according to any one of [20] to [38], above, wherein the product coil has a diffusible hydrogen content of 0.50 mass ppm or less.

### Advantageous Effect

According to the present disclosure, a steel sheet having excellent hydrogen embrittlement resistance may be produced without changing mechanical properties of the steel sheet.

### BRIEF DESCRIPTION OF THE DRAWINGS

In the accompanying drawings:

FIG. 1 is a diagram illustrating an example configuration of a magnetic field applying apparatus;

FIG. 2A to FIG. 2D are overview diagrams to illustrate an example configuration of a dehydrogenation apparatus according to Embodiment 1: FIG. 2A is a perspective view of the dehydrogenation apparatus, FIG. 2B is a view of the dehydrogenation apparatus from side a, FIG. 2C is an example of a view of the dehydrogenation apparatus from side b, and FIG. 2D is a view of another example of the dehydrogenation apparatus from side b;

FIG. 3 is a diagram illustrating an example configuration of the dehydrogenation apparatus according to Embodiment 2, viewed from a coil axis direction of a steel sheet coil; and

FIG. 4A and FIG. 4B are diagrams schematically illustrating examples of disposition of a pair of electromagnets 60A, 60B as a magnetic field applying apparatus with respect to an uncoiled steel sheet in the dehydrogenation apparatus according to Embodiment 2.

### DETAILED DESCRIPTION

The following describes embodiments of the present disclosure. The present disclosure is not limited to the following embodiments. Hereinafter, a numerical range expressed by using “to” means a range including numerical values before and after “to” as the lower limit value and the upper limit value. Hereinafter, “steel sheet” is a generic term that includes a hot-rolled steel sheet, a cold-rolled steel sheet, an annealed steel sheet after further annealing, and a coated or plated steel sheet with a coating or plating formed on a surface thereof. The form of a “steel sheet” is not limited and includes both a steel sheet coil and an uncoiled steel strip.

The dehydrogenation apparatus applies a steady magnetic field along the sheet transverse direction of a steel sheet to decrease diffusible hydrogen content in the steel. According to the dehydrogenation apparatus, heat treatment of a steel sheet is not required, and therefore diffusible hydrogen content in the steel may be decreased without concern about changing microstructure properties of the steel sheet.

Further, according to the method of producing a steel sheet, a steady magnetic field is applied along the sheet transverse direction of the steel sheet. According to the method of producing a steel sheet, heat treatment of a steel sheet is not required, and therefore diffusible hydrogen content in the steel may be decreased without concern about changing microstructure properties of the steel sheet.

In the following, description is divided into (1) a dehydrogenation apparatus and a method of producing a steel sheet that apply a steady magnetic field to a steel sheet coil, and (2) a dehydrogenation apparatus and a method of producing a steel sheet that apply a steady magnetic field to a steel sheet that is uncoiled and fed out from a steel sheet coil, then recoiled.

### Embodiment 1

The dehydrogenation apparatus according to the present embodiment is a dehydrogenation apparatus including a housing that accommodates a steel sheet coil C of a steel strip coiled into a coil shape, and a magnetic field applying apparatus that applies a steady magnetic field along the sheet transverse direction of the steel sheet coil in the housing. In various processes in steel sheet production, steel strips are coiled to obtain steel sheet coils.

Further, the method of producing a steel sheet according to the present embodiment includes a magnetic field applying process of applying a steady magnetic field to a steel sheet coil obtained by coiling a steel strip, along the sheet transverse direction of the steel sheet coil. In various processes in steel sheet production, steel strips are coiled to obtain steel sheet coils.

According to the dehydrogenation apparatus and the method of producing a steel sheet of the present embodiment, a steady magnetic field is applied along the sheet transverse direction of the steel sheet coil to decrease diffusible hydrogen content in the steel and obtain a steel sheet having excellent hydrogen embrittlement resistance. In particular, in a steel sheet coil, the steel strip is subjected to bending deformation and lattice spacing on an outer radial direction face of the steel strip is expanded, and therefore hydrogen diffusion paths are likely to form toward the outer radial direction. According to the present embodiment, a steady magnetic field is applied along the sheet transverse direction of the steel sheet coil, which further expands the steel strip along the sheet transverse direction with an expanded lattice spacing on the outer radial direction face, thereby more suitably decreasing diffusible hydrogen in the steel.

### [Magnetic Field Applying Apparatus]

### (Magnetic Field Applying Apparatus 60)

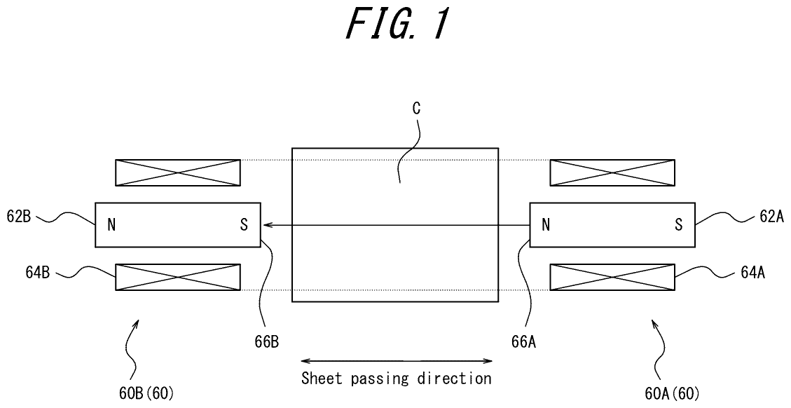

A magnetic field applying apparatus can be used to apply a steady magnetic field. FIG. 1 illustrates an example configuration of a magnetic field applying apparatus. As an example, the magnetic field applying apparatus 60 includes a pair of electromagnets 60A, 60B disposed outside sheet transverse direction ends of a steel sheet coil C. The electromagnets 60A, 60B respectively include iron cores 62A, 62B, coils 64A, 64B wound around the iron cores 62A, 62B, and a driving power source (not illustrated) to pass current through the coils 64A, 64B. By turning on the driving power source and applying a continuous direct current to the coils 64A, 64B, the electromagnets 60A, 60B can be magnetized to generate a steady magnetic field. The axial direction of the coils 64A, 64B coincides with the sheet transverse direction of the steel sheet coil C. The pair of the electromagnets 60A, 60B respectively have magnetic pole faces 66A, 66B that face sheet transverse direction end surfaces of the steel sheet coil C from a defined distance. By controlling the direction of the current flowing in the coils 64A, 64B, the magnetic pole face 66A can be the N pole and the magnetic pole face 66B can be the S pole. The pair of the magnetic pole surfaces 66A, 66B are in the same position with respect to both sheet transverse direction ends of the steel sheet coil C and face each other across the steel sheet coil C. Accordingly, as illustrated in FIG. 1, the steady magnetic field generated by the pair of the electromagnets 60A, 60B has a main flux going from the magnetic pole face 66A (N pole) to the magnetic pole face 66B (S pole), the direction of which matches the sheet transverse direction of the steel sheet coil C. This allows the application of a uniform steady magnetic field along the sheet transverse direction of the steel sheet coil C. According to the present disclosure, “continuous direct current” means a DC in which current value is maintained continuously (preferably constantly) rather than pulse-like. Further, the term “steady magnetic field” as used herein means a magnetic field that is not pulsed but is continuously maintained, and includes the magnetic field formed by a stationary magnet and the magnetic field formed by an electromagnet supplied with a continuous direct current. Further, “surface of the steel sheet coil” means a surface of the steel sheet at the outermost circumference in the radial direction of the steel sheet coil C.

It is important to apply a steady magnetic field, not a pulsed magnetic field, to the steel sheet coil C. In a pulsed magnetic field, expansion of lattice spacing of the steel sheet due to the magnetostriction effect is not sustained, and hydrogen cannot be efficiently desorbed from the steel sheet coil C. Further, it is important to apply a magnetic field along the sheet transverse direction of the steel sheet coil C. For example, when a magnetic field is applied along a thickness direction of the steel sheet coil C, lattice spacing of the steel sheet expands along the thickness direction of the steel sheet. In such a case, hydrogen inside the steel sheet diffuses in the in-plane direction of the steel sheet and can desorb from the transverse direction edge surface of the steel sheet. However, the area of the sheet transverse direction end surface of the steel sheet is very small, and therefore sufficient hydrogen desorption cannot be achieved. In contrast, when a magnetic field is applied along the sheet transverse direction of the steel sheet coil C, the lattice spacing of the steel sheet expands in a main surface (front and back) direction of the steel sheet, along the sheet transverse direction. As a result, hydrogen in the steel sheet diffuses toward the main surfaces (front and back) of the steel sheet, which have a large surface area, and desorbs from the main surfaces. Therefore, a sufficient hydrogen desorption effect may be obtained.

The disposition of the pair of the electromagnets 60A, 60B is preferred as described above, but the disposition is not limited as long as a steady magnetic field having a magnetic flux component in the sheet transverse direction of the steel sheet coil C is generated. Further, configuration of the magnetic field applying apparatus 60 is not limited to the pair of the electromagnets 60A, 60B described above as long as a steady magnetic field having a magnetic flux component in the sheet transverse direction of the steel strip S is generated. For example, the magnetic field applying apparatus 60 may be only the electromagnet 60A or only the electromagnet 60B. When the magnetic field formed by one of the electromagnets is strong enough to apply a magnetic field along the sheet transverse direction to the entire width of the steel sheet coil C, a configuration including only one of the electromagnets may be used.

### [Dehydrogenation Apparatus]

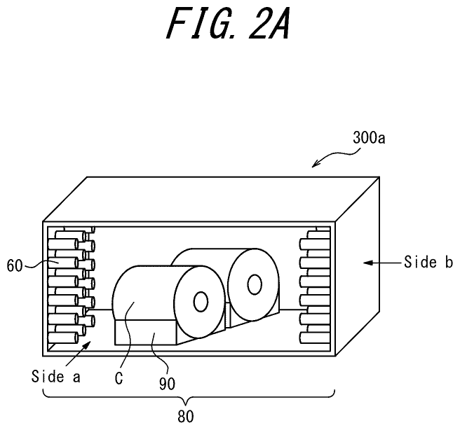

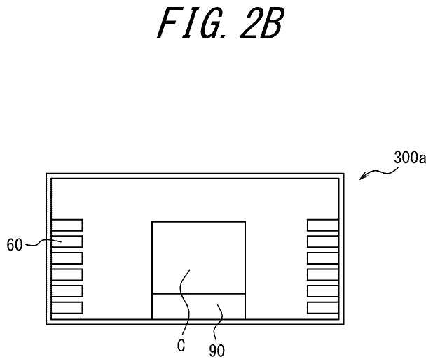

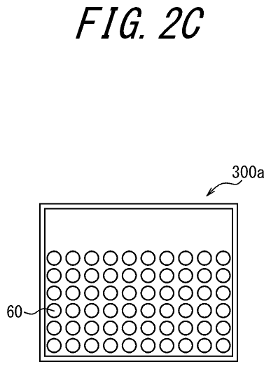

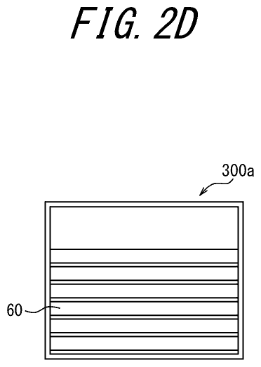

FIG. 2A to FIG. 2D illustrate an example of a dehydrogenation apparatus for decreasing diffusible hydrogen content in steel by applying a steady magnetic field to the steel sheet coil C by using the magnetic field applying apparatus 60. FIG. 2A is a perspective view diagram of a dehydrogenation apparatus 300a. In FIG. 2A, only some frontmost rows of the magnetic field applying apparatus 60 are illustrated, when viewed from side a of the dehydrogenation apparatus 300a. FIG. 2B illustrates the dehydrogenation apparatus 300a viewed from the side a. As illustrated in FIG. 2A and FIG. 2B, the dehydrogenation apparatus 300a includes a housing 80 for accommodating the steel sheet coil C and the magnetic field applying apparatus 60 that applies a steady magnetic field to the steel sheet coil C in the housing 80. The number and arrangement of the magnetic field applying apparatus 60 are not particularly limited. In the example in FIG. 2A and FIG. 2B, a plurality of the magnetic field applying apparatus 60 is arranged outside the sheet transverse direction end of the steel sheet coil C. Although not illustrated in FIG. 2A to FIG. 2D, a driving power source is coupled to each of the magnetic field applying apparatus 60, so that a steady magnetic field is applied along the sheet transverse direction of the steel sheet coil C from each of the magnetic field applying apparatus 60. As illustrated, a plurality of the steel sheet coil C may be accommodated in the housing 80.

As illustrated, a coil holder 90 is provided as appropriate in the dehydrogenation apparatus 300a. The form of the coil holder 90 is not particularly limited. When the steel sheet coil C is placed so that the coil axis direction of the steel sheet coil C is parallel to the floor of the dehydrogenation apparatus 300a, the coil holder 90 may be a pair of bar-shaped members holding the steel sheet coil C from both sides to prevent rolling in the dehydrogenation apparatus 300a, as illustrated in FIG. 2A. The coil holder 90 may be a pair of bar-shaped members having a concave arc-shaped top surface along an arc drawn by the outermost circumference of the steel sheet coil C, as illustrated in FIG. 2A. Although not illustrated, the steel sheet coil C may be placed so that the coil axis direction is perpendicular to the floor of the dehydrogenation apparatus 300a.

### (Magnetic Flux Density)

From the viewpoint of promoting hydrogen diffusion and sufficiently desorbing hydrogen content in the steel sheet coil C, the magnetic flux density of the steel sheet coil C to the sheet transverse direction is preferably 0.1 T or more. The magnetic flux density is more preferably 0.2 T or more. The magnetic flux density is even more preferably 0.5 T or more. On the other hand, considering the performance of typical magnetic field applying apparatus, the magnetic flux density to the sheet transverse direction of the steel sheet coil C is preferably 15 T or less. The magnetic flux density is more preferably 14 T or less. The magnetic flux density to the sheet transverse direction of the steel strip S can be adjusted by adjusting the number of coil turns and current value. Here, “magnetic flux density to the sheet transverse direction of the steel sheet coil C” can be measured in-line by installing a Tesla meter in the vicinity of a transverse direction edge of the steel sheet coil C, and in the vicinity of a magnetic field generating surface of the magnetic field applying apparatus 60. Alternatively, once the number of coil turns in the magnetic field applying apparatus 60 and the magnitude of the current value are determined, “magnetic flux density to the sheet transverse direction of the steel sheet coil C” can be determined off-line in advance.

### (Magnetic Field Application Time)

The time to apply a steady magnetic field to the steel sheet coil C is not particularly limited. According to the present embodiment, a steady magnetic field is applied to the steel sheet coil after hot rolling or after cold rolling, and therefore unlike a case where a steady magnetic field is applied to a steel strip being passed, a steady magnetic field can be applied without any restriction on application time. It may be presumed that the longer a steady magnetic field is applied, the more diffusible hydrogen content can be decreased, and therefore the application time of a steady magnetic field is preferably 0.5 min or more. The application time of a steady magnetic field is more preferably 30 min or more. The application time of a steady magnetic field is even more preferably 60 min or more. On the other hand, from the viewpoint of productivity, the application time of a steady magnetic field is preferably 30,000 min or less. The application time of a steady magnetic field is more preferably 10,000 min or less. The application time of a steady magnetic field is even more preferably 1,000 min or less. As a method of controlling the application time of a steady magnetic field, an example is by controlling drive time of the magnetic field applying apparatus 60.

### [Heating Apparatus]

### [Holding Temperature of Steel Sheet Coil]

The dehydrogenation apparatus 300a may further include a heater for heating the steel sheet coil C while applying a steady magnetic field. The temperature of the steel sheet coil C in the magnetic field applying process is not particularly limited. This is because, according to the present embodiment, diffusible hydrogen content in steel may be decreased without heating and holding temperature of the steel sheet coil C. However, by heating the steel sheet coil C by the heater while applying a steady magnetic field, the diffusion rate of hydrogen may be increased and the diffusible hydrogen content in the steel may be further decreased. Accordingly, the temperature of the steel sheet coil C when applying a steady magnetic field is preferably 30° C. or more. The temperature of the steel sheet coil C when applying a steady magnetic field is more preferably 50° C. or more. The temperature of the steel sheet coil C when applying a steady magnetic field is even more preferably 100° C. or more. An upper limit of temperature of the steel sheet coil C in the magnetic field applying process is not particularly limited. From the viewpoint of suitably preventing microstructural changes in the steel sheet coil C, the temperature is preferably 300° C. or less, except when a steady magnetic field is applied during batch annealing, as described below. According to the present embodiment, the temperature of the steel sheet coil C when a steady magnetic field is applied is based on the temperature at a position halfway along the radial direction of the steel sheet coil. The temperature at the position halfway along the radial direction of the steel sheet coil can be measured by inserting a thermocouple directly into the position halfway along the radial direction of the steel sheet coil and measuring the temperature of the steel strip present at the position halfway along the radial direction. The steel sheet coil C may be heated by a typical method, such as by installing a heater on a housing side wall, or by blowing hot air generated externally into the housing and circulating the hot air within the housing.

The dehydrogenation apparatus 300a according to the present embodiment may further include a magnetic field blocker to prevent a steady magnetic field from being transmitted outside the dehydrogenation apparatus 300a. The magnetic field blocker may be, for example, a magnetic field blocking material surrounding an inner wall of the housing 80.

According to the present embodiment, the diffusible hydrogen content in a product coil C obtained after magnetic field application may be decreased to 0.50 mass ppm or less. By decreasing the diffusible hydrogen content in the product coil C to 0.50 mass ppm or less, hydrogen embrittlement of the steel sheet may be prevented. The diffusible hydrogen content in the steel after magnetic field application is preferably 0.30 mass ppm or less. The diffusible hydrogen content in the steel after magnetic field application is even more preferably 0.20 mass ppm or less.

The diffusible hydrogen content of the product coil C is measured as follows. A test piece 30 mm long and 5 mm wide is taken from the position halfway along the radial direction of the product coil. When the steel sheet is a hot-dip galvanized steel sheet or a galvannealed steel sheet, the hot-dip galvanized layer or the galvannealed layer of the test piece is removed by grinding or alkali. An amount of hydrogen released from the test piece is then measured by thermal desorption spectrometry (TDS). Specifically, the test piece is continuously heated from room temperature to 300° C. at a heating rate of 200° C./h, then cooled to room temperature, and a cumulative hydrogen amount released from the test piece from room temperature to 210° C. is measured to determine the diffusible hydrogen content of the product coil.

The following is a more specific explanation of application of the present embodiment.

### [Hot-Rolled Steel Sheet]

The dehydrogenation apparatus 300a and the method of producing a steel sheet according to the present embodiment can be applied to the production of a hot-rolled steel sheet.

The steel sheet production system for the present application example is a steel sheet production system including a hot rolling apparatus that hot rolls a steel slab to obtain a hot-rolled steel sheet, a hot-rolled steel sheet coiling apparatus that coils the hot-rolled steel sheet to obtain a hot-rolled coil, and a steel sheet dehydrogenation apparatus that treats the hot-rolled coil as the steel sheet coil C. The hot rolling apparatus applies hot rolling, consisting of rough rolling and finish rolling, to a steel slab having a known chemical composition to obtain a hot-rolled steel sheet. The hot-rolled steel sheet coiling apparatus coils the hot-rolled steel sheet to obtain a hot-rolled coil. The dehydrogenation apparatus 300a applies a steady magnetic field to the hot-rolled coil under the conditions described above, with the hot-rolled coil as the steel sheet coil C. The application of a steady magnetic field decreases diffusible hydrogen content in the steel and may obtain a hot-rolled steel sheet having excellent hydrogen embrittlement resistance. The obtained hot-rolled steel sheet may be further cold rolled to obtain a cold-rolled steel sheet.

The method of producing a steel sheet according to the present application example includes a process of hot rolling a steel slab to obtain a hot-rolled steel sheet and a process of coiling the hot-rolled steel sheet to obtain a hot-rolled coil, with the hot-rolled coil as the steel sheet coil. The method of producing a hot-rolled coil prior to applying a steady magnetic field is not particularly limited. A steel slab having a known chemical composition is subjected to hot rolling, which consists of rough rolling and finish rolling, to obtain a hot-rolled steel sheet, and the hot-rolled steel sheet is then coiled into a hot-rolled coil according to a known method. By applying a steady magnetic field to the hot-rolled coil under the conditions described above, diffusible hydrogen content in the steel may be decreased to obtain a hot-rolled steel sheet having excellent hydrogen embrittlement resistance. The obtained hot-rolled steel sheet may be further cold rolled to obtain a cold-rolled steel sheet.

### [Cold-Rolled Steel Sheet]

The dehydrogenation apparatus 300a and the method of producing a steel sheet according to the present embodiment can also be applied to the production of a cold-rolled steel sheet.

The steel sheet production system for the present application example is a steel sheet production system including a cold rolling apparatus that cold rolls a hot-rolled steel sheet to obtain a cold-rolled steel sheet, a cold-rolled steel sheet coiling apparatus that coils the cold-rolled steel sheet to obtain a cold-rolled coil, and the dehydrogenation apparatus 300a that treats the cold-rolled coil as the steel sheet coil C. With respect to a known hot-rolled steel sheet, either subjected to hot-rolled sheet annealing or not, the cold rolling mill applies one pass of cold rolling or two or more passes of cold rolling with intermediate annealing to the hot-rolled steel sheet after hot rolling or to the hot-rolled steel sheet after hot-rolled sheet annealing, to obtain a cold-rolled steel sheet having a final sheet thickness. The cold-rolled steel sheet coiling apparatus coils the cold-rolled steel sheet after cold rolling into a cold-rolled coil according to a known method. The dehydrogenation apparatus 300a applies a steady magnetic field to the cold-rolled coil under the conditions described above, with the cold-rolled coil as the steel sheet coil C. The application of a steady magnetic field decreases diffusible hydrogen content in the steel and may obtain a cold-rolled steel sheet having excellent hydrogen embrittlement resistance. The steel sheet production system may further include the dehydrogenation apparatus 300a that can apply a steady magnetic field to the hot-rolled coil that is obtained by coiling the hot-rolled steel sheet after hot rolling, under the conditions described above. Subsequently, the hot-rolled coil is uncoiled to feed out the hot-rolled steel sheet after the magnetic field has been applied and cold rolling is applied to obtain a cold-rolled coil. A steady magnetic field is further applied to the cold-rolled coil by the dehydrogenation apparatus 300a to further decrease the diffusible hydrogen content in the steel and obtain a steel sheet having particularly excellent hydrogen embrittlement resistance.

The method of producing a steel sheet according to the present application example includes a process of cold rolling a hot-rolled steel sheet to obtain a cold-rolled steel sheet and a process of coiling the cold-rolled steel sheet to obtain a cold-rolled coil, with the cold-rolled coil as the steel sheet coil. A method of producing a cold-rolled coil before applying a steady magnetic field is not particularly limited. As an example, a steel slab having a known chemical composition is hot rolled, consisting of rough rolling and finish rolling, to obtain a hot-rolled steel sheet, which is then hot rolled with or without hot-rolled sheet annealing. The hot-rolled steel sheet after hot rolling or hot-rolled sheet annealing is cold rolled once or cold rolled two or more times with intermediate annealing to obtain a cold-rolled steel sheet having a final thickness. The cold-rolled steel sheet after cold rolling is coiled into a cold-rolled coil according to a known method. By applying a steady magnetic field to the cold-rolled coil under the conditions described above, diffusible hydrogen content in the steel may be decreased to obtain a cold-rolled steel sheet having excellent hydrogen embrittlement resistance. In addition to applying a steady magnetic field to the cold-rolled coil, a steady magnetic field may also be applied to the hot-rolled coil under the conditions described above after the hot-rolled steel sheet is coiled to obtain the hot-rolled coil. Subsequently, the hot-rolled coil is uncoiled to feed the hot-rolled steel sheet after the magnetic field has been applied and cold rolling is applied to obtain a cold-rolled coil. A steady magnetic field is further applied to the cold-rolled coil to further decrease the diffusible hydrogen content in the steel and obtain a steel sheet having particularly excellent hydrogen embrittlement resistance.

According to the present embodiment, the type of hot-rolled steel sheet or cold-rolled steel sheet to which a steady magnetic field is applied is not particularly limited. The chemical composition of a steel sheet is not particularly limited. As a steel sheet to which the embodiment can be particularly suitably applied, a steel sheet having the following composition is an example. First, appropriate ranges for a chemical composition of a steel sheet and reasons for such limitations are described.

### [Essential Components]

### C: 0.030% or More and 0.800% or Less

C is an element required to increase strength. By setting C content to 0.030% or more, particularly suitable strength is obtainable. Further, by setting the C content to 0.800% or less, embrittlement of the material itself may be particularly suitably prevented. From this perspective, the C content is preferably 0.030% or more. The C content is preferably 0.800% or less. The C content is more preferably 0.080% or more. Further, the C content is more preferably 0.500% or less.

### Si: 0.01% or More and 3.00% or Less

Si is a solid-solution-strengthening element that greatly hardens a material property as a substitutional solute and is effective in increasing steel sheet strength. To obtain the effect of increased strength by Si addition, Si content is preferably 0.01% or more. On the other hand, from the viewpoint of preventing steel embrittlement and a decrease in ductility, and further preventing red scale and the like to obtain good surface characteristics and thereby obtain good coating appearance and coating adhesion, the Si content is preferably 3.00% or less. Accordingly, the Si content is preferably 0.01% or more. The Si content is preferably 3.00% or less. The Si content is more preferably 0.10% or more. The Si content is more preferably 2.50% or less.

### Mn: 0.01% or More and 10.00% or Less

Mn increases steel sheet strength through solid solution strengthening. To obtain this effect, Mn content is preferably 0.01% or more. On the other hand, by keeping the Mn content 10.00% or less, Mn segregation may be suitably prevented and unevenness in steel microstructure may be prevented to further suppress hydrogen embrittlement. The Mn content is therefore preferably 10.00% or less. The Mn content is more preferably 0.5% or more. The Mn content is more preferably 8.00% or less.

### P: 0.001% or More and 0.100% or Less

P is an element that has a solid solution strengthening effect and can be added depending on desired strength. To obtain this effect, P content is preferably 0.001% or more. On the other hand, excellent weldability may be obtained by keeping the P content 0.100% or less. Further, by setting the P content to 0.100% or less, when a galvanized coating or plating is formed on a steel sheet surface and alloying treatment is applied to the galvanized coating or plating to form an alloyed galvanized coating or plating, a decrease in alloying speed may be prevented and a galvanized coating or plating of excellent quality may be formed. Accordingly, the P content is preferably 0.001% or more. The P content is preferably and 0.100% or less. The P content is more preferably 0.003% or more. Further, the P content is more preferably 0.050% or less.

### S: 0.0001% or More and 0.0200% or Less

By decreasing S content, embrittlement of steel during hot working may be suitably prevented, and local deformation capacity may be improved by suitable prevention of sulfide formation. Accordingly, the S content is preferably 0.0200% or less. The S content is more preferably 0.0100% or less. The S content is even more preferably 0.0050% or less. A lower limit of the S content is not particularly limited. In view of production technology constraints, the S content is preferably 0.0001% or more. The S content is more preferably 0.0050% or more.

### N: 0.0005% or More and 0.0100% or Less

Decreasing N content improves steel anti-aging property. Accordingly, the N content is preferably 0.0100% or less. The N content is more preferably 0.0070% or less. A lower limit of the N content is not particularly limited. In view of production technology constraints, the N content is preferably 0.0005% or more. The N content is more preferably 0.0010% or more.

### Al: 2.000% or Less

Al acts as a deoxidizer, is an effective element for steel cleanliness, and is preferably added in a deoxidation process. To obtain the effect of addition, Al content, when added, is preferably 0.001% or more. On the other hand, from the viewpoint of suitably preventing slab cracking during continuous casting, the Al content is preferably 2.000% or less. The Al content is more preferably 0.010% or more. Further, the Al content is more preferably 1.200% or less.

### [Optional Components]

The chemical composition may further contain, in mass %, at least one element selected from the group consisting of Ti: 0.200% or less, Nb: 0.200% or less, V: 0.500% or less, W: 0.500% or less, B: 0.0050% or less, Ni: 1.000% or less, Cr: 1.000% or less, Mo: 1.000% or less, Cu: 1.000% or less, Sn: 0.200% or less, Sb: 0.200% or less, Ta: 0.100% or less, Ca: 0.0050% or less, Mg: 0.0050% or less, Zr: 0.0050% or less, and REM: 0.0050% or less.

### Ti: 0.200% or Less

Ti contributes to steel sheet strength increase through steel strengthening by precipitation and fine grain strengthening through ferrite crystal grain growth inhibition. When added, Ti content is preferably 0.005% or more. When Ti is added, the Ti content is more preferably 0.010% or more. Further, by setting the Ti content to 0.200% or less, precipitation of carbonitride may be suitably prevented and formability may be further improved. Accordingly, when Ti is added, the Ti content is preferably 0.200% or less. The Ti content is more preferably 0.100% or less.

### Nb: 0.200% or Less, V: 0.500% or Less, W: 0.500% or Less

Nb, V, and W are effective for steel strengthening by precipitation. When added, each of Nb, V, and W content is preferably 0.005% or more. When added, each of Nb, V, and W content is more preferably 0.010% or more. Further, by setting Nb at 0.200% or less, and V and W at 0.500% or less, then, as with Ti, precipitation of carbonitride may be suitably prevented, and formability may be further improved. Accordingly, when Nb is added, Nb content is preferably 0.200% or less. The Nb content is more preferably 0.100% or less. When added, each of V and W content is preferably 0.500% or less. Each of V and W content is more preferably 0.300% or less.

### B: 0.0050% or Less

B is effective in grain boundary strengthening and increasing steel sheet strength. When added, B content is preferably 0.0003% or more. Further, in order to obtain more suitable formability, the B content is preferably 0.0050% or less. Accordingly, when added, the B content is preferably 0.0050% or less. The B content is more preferably 0.0030% or less.

### Ni: 1.000% or Less

Ni is an element that increases steel strength through solid solution strengthening. When added, Ni content is preferably 0.005% or more. Further, from the viewpoint of decreasing an area fraction of hard martensite to further improve ductility, the Ni content is preferably 1.000% or less. Accordingly, when added, the Ni content is preferably 1.000% or less. The Ni content is more preferably 0.500% or less.

### Cr: 1.000% or Less, Mo: 1.000% or Less

Cr and Mo act to improve balance between strength and formability, and therefore may be added as required. When added, Cr content is preferably 0.005% or more and Mo content is preferably 0.005% or more. From the viewpoint of decreasing an area fraction of hard martensite to further improve ductility, the Cr content is preferably 1.000% or less and the Mo content is preferably 1.000% or less. The Cr content is more preferably 0.500% or less. The Mo content is more preferably 0.500% or less.

### Cu: 1.000% or Less

Cu is an effective element for strengthening steel and may be added as required. When added, Cu content is preferably 0.005% or more. From the viewpoint of decreasing an area fraction of hard martensite to further improve ductility, when added, the Cu content is preferably 1.000% or less. The Cu content is more preferably 0.200% or less.

### Sn: 0.200% or Less, Sb: 0.200% or Less

Sn and Sb suppress decarburization in a region of some tens of μm in a steel sheet surface layer caused by nitridation and oxidation at the steel sheet surface, and are therefore effective in securing strength and stability of a steel sheet as a material when added as required. When added, each of Sn and Sb content is preferably 0.002% or more. Further, in order to obtain better toughness, when added, each of Sn and Sb content is preferably 0.200% or less. Each of Sn and Sb content is more preferably 0.050% or less.

### Ta: 0.100% or Less

Ta, like Ti and Nb, forms alloy carbides and alloy carbonitrides, and contributes to increasing steel strength. In addition, it is believed that Ta has an effect of significantly inhibiting coarsening of precipitates when partially dissolved in Nb carbides or Nb carbonitrides to form complex precipitates such as (Nb, Ta) (C, N), and of stabilizing a contribution to strength through strengthening by precipitation. Ta is therefore preferably added. When added, Ta content is preferably 0.001% or more. An upper limit of the Ta content is not particularly limited. From the viewpoint of cost reduction, when added, the Ta content is preferably 0.100% or less. The Ta content is more preferably 0.050% or less.

### Ca: 0.0050% or Less, Mg: 0.0050% or Less, Zr: 0.0050% or Less, REM: 0.0050% or Less

Ca, Mg, Zr, and REM are effective elements for spheroidizing the shape of sulfides and mitigating the adverse effects of sulfides on formability. When added, content of each of these elements is preferably 0.0005% or more. Further, in order to suitably prevent an increase in inclusions and the like, and to better prevent surface and internal defects and the like, then, when added, each of Ca, Mg, Zr, and REM content is preferably 0.0050% or less. Each of Ca, Mg, Zr, and REM content is more preferably 0.0020% or less.

The present embodiment can be suitably applied to high strength steel sheets, where hydrogen embrittlement is particularly problematic. By applying a steady magnetic field to the steel sheet coil C made from a high strength steel sheet via the dehydrogenation apparatus 300a or the present method of producing a steel sheet, diffusible hydrogen content in the steel may be decreased to obtain a high strength steel sheet having excellent hydrogen embrittlement resistance. For example, a steel sheet produced according to the present embodiment may be a high strength steel sheet having a tensile strength of 590 MPa or more. The tensile strength may more preferably be 1180 MPa or more. The tensile strength may even more preferably be 1470 MPa or more. Steel sheet tensile strength is measured in accordance with Japanese Industrial Standard JIS Z 2241 (2011). Delayed fracture due to hydrogen embrittlement is often a problem in high strength steel sheets, but the present embodiment may produce a high strength steel sheet having excellent hydrogen embrittlement resistance without loss of tensile strength.

Further, according to the dehydrogenation apparatus and the method of producing a steel sheet of the present embodiment, a steady magnetic field may be applied to known stainless steel to produce stainless steel having excellent hydrogen embrittlement resistance. The following describes chemical composition and reasons for limitation of the chemical composition when the steel sheet is a stainless steel sheet.

### [Essential Components]

### C: 0.001% or More and 0.400% or Less

C is an essential element for obtaining high strength in stainless steel. However, when the C content exceeds 0.400%, C combines with Cr during tempering in steel production and precipitates as carbides, which degrade steel corrosion resistance and toughness. When C content is less than 0.001%, sufficient strength cannot be obtained. When the C content exceeds 0.400%, the degradation described above becomes more pronounced. The C content is therefore 0.001% or more and 0.400% or less. The C content is preferably 0.005% or more. Further, the C content is preferably 0.350% or less.

### Si: 0.01% or More and 2.00% or Less

Si is a useful element as a deoxidizer. This effect is obtained by setting Si content to 0.01% or more. However, when the Si content is excessive, solute Si in steel decreases steel workability. Accordingly, an upper limit of the Si content is 2.00%. The S content is preferably 0.05% or more. Further, the Si content is preferably 1.8% or less.

### Mn: 0.01% or More and 5.00% or Less

Mn has an effect of increasing steel strength. This effect is obtained when Mn content is 0.01% or more. However, when the Mn content exceeds 5.00%, steel workability decreases. Accordingly, an upper limit of the Mn content is 5.00%. The Mn content is preferably 0.05% or more. Further, the Mn content is preferably 4.6% or less.

### P: 0.001% or More and 0.100% or Less

P is an element that promotes intergranular fracture by grain boundary segregation, and therefore lower content is better. An upper limit of P content is 0.100%. The P content is preferably 0.030% or less. The P content is more preferably 0.020% or less. A lower limit of the P content is not particularly limited. In view of production technology, the P content is 0.001% or more.

### S: 0.0001% or More and 0.0200% or Less

S is an element that is present as a sulfide inclusion such as MnS and decreases ductility, corrosion resistance, and the like. The adverse effects are particularly noticeable when S content is more than 0.0200%. Accordingly, the S content is desirably as low as possible. An upper limit of the S content is 0.0200%. The S content is preferably 0.010% or less. The S content is more preferably 0.005% or less. A lower limit of the S content is not particularly limited. In view of production technology, the S content is 0.0001% or more.

### Cr: 9.0% or More and 28.0% or Less

Cr is a basic element of stainless steel and is also an important element for corrosion resistance. When considering corrosion resistance in severe environments of 180° C. or more, Cr content of less than 9% does not provide sufficient corrosion resistance, while Cr content exceeding 28.0% saturates the effect and causes problems in terms of economic efficiency. The Cr content is therefore 9.0% or more and 28.0% or less. The Cr content is preferably 10.0% or more. Further, the Cr content is preferably 25.0% or less.

### Ni: 0.01% or More and 40.0% or Less

Ni is an element that improves corrosion resistance of stainless steel, but this effect is not fully realized when Ni content is less than 0.01%. On the other hand, excessive addition of Ni hardens stainless steel, degrades formability, and increases susceptibility to stress corrosion cracking. The Ni content is therefore 0.01% or more and 40.0% or less. The Ni content is preferably 0.1% or more. Further, the Ni content is preferably 30.0% or less.

### N: 0.0005% or More and 0.500% or Less

N is a detrimental element to corrosion resistance of stainless steel, but is also an austenite forming element. When content exceeds 0.5%, N precipitates as nitrides during heat treatment, which degrades corrosion resistance and toughness of stainless steel. An upper limit of N content is therefore 0.500%. The N content is preferably 0.20% or less.

### Al: 3.000% or Less

Al is added as a deoxidation element and also has an effect of suppressing oxide scale separation. However, addition of more than 3.000% leads to a decrease in elongation and degradation of surface quality. An upper limit of the Al content is therefore 3.000%. A lower limit of the Al content is not particularly limited. The Al content is preferably 0.001% or more. The Al content is more preferably 0.01% or more. Further, the Al content is preferably 2.5% or less.

### [Optional Components]

The chemical composition of stainless steel may further contain, in mass %, at least one element selected from the group consisting of Ti: 0.500% or less, Nb: 0.500% or less, V: 0.500% or less, W: 2.000% or less, B: 0.0050% or less, Mo: 2.000% or less, Cu: 3.000% or less, Sn: 0.500% or less, Sb: 0.200% or less, Ta: 0.100% or less, Ca: 0.0050% or less, Mg: 0.0050% or less, Zr: 0.0050% or less, and REM: 0.0050% or less.

### Ti: 0.500% or Less

Ti is an element added to improve corrosion resistance, intergranular corrosion resistance, and depth drawability by combining with C, N, and S. However, when more than 0.500% is added, stainless steel becomes harder due to solute Ti, and toughness degrades. An upper limit of Ti content is therefore 0.500%. The lower limit of the Ti content is not particularly limited. The Ti content is preferably 0.003% or more. The Ti content is more preferably 0.005% or more. Further, the Ti content is preferably 0.300% or less.

### Nb: 0.500% or Less

Nb, like Ti, is an element added to improve corrosion resistance, intergranular corrosion resistance, and depth drawability by combining with C, N, and S. Further, Nb is added as required to inhibit crevice corrosion and promote repassivation, and to improve workability and high-temperature strength. However, excessive addition of causes stainless steel to become harder and degrades formability, and therefore an upper limit of Nb content is 0.500%. A lower limit of the Nb content is not particularly limited. The Nb content is preferably 0.003% or more. The Nb content is more preferably 0.005% or more. Further, the Nb content is preferably 0.300% or less.

### V: 0.500% or Less

V is added as required to suppress crevice corrosion. However, excessive addition hardens stainless steel and degrades formability, and therefore an upper limit of V content is 0.500%. A lower limit of the V content is not particularly limited. The V content is preferably 0.01% or more. The V content is more preferably 0.03% or more. Further, the V content is preferably 0.300% or less.

### W: 2.000% or Less

W is added as required to improve corrosion resistance and high-temperature strength. However, addition of more than 2.000% makes stainless steel harder, leading to toughness degradation and cost increase during steel sheet production, and therefore an upper limit of W content is 2.000%. A lower limit of the W content is not particularly limited. The W content is preferably 0.050% or more. The W content is more preferably 0.010% or more. Further, the W content is preferably 1.500% or less.

### B: 0.0050% or Less

B is an element that improves secondary workability of the product by segregation at grain boundaries. B is added as required to suppress longitudinal cracking during secondary working of components and also to prevent cracking in winter. However, excessive addition decreases workability and corrosion resistance. An upper limit of the B content is therefore 0.0050%. A lower limit of the B content is not particularly limited. The B content is preferably 0.0002% or more. The B content is more preferably 0.0005% or more. Further, the B content is preferably 0.0035% or less.

### Mo: 2.000% or Less

Mo is an element that improves corrosion resistance and suppresses crevice corrosion, particularly in the case of structures with crevices. However, when content exceeds 2.000%, formability degrades significantly, and therefore an upper limit of the content is 2.000%. A lower limit of Mo content is not particularly limited. The Mo content is preferably 0.005% or more. The Mo content is more preferably 0.010% or more. Further, the Mo content is preferably 1.500% or less.

### Cu: 3.000% or Less

Cu, like Ni and Mn, is an austenite-stabilizing element and is effective in crystal grain refinement through phase transformation. Further, Cu is added as required to suppress crevice corrosion and promote repassivation. However, excessive addition results in hardening and degradation of toughness and formability, and therefore an upper limit of content is 3.000%. A lower limit of Cu content is not particularly limited. The Cu content is preferably 0.005% or more. The Cu content is more preferably 0.010% or more. Further, the Cu content is preferably 2.000% or less.

### Sn: 0.500% or Less

Sn is added as required to improve corrosion resistance and high-temperature strength. However, when more than 0.500% is added, slab cracking may occur during steel sheet production, and therefore an upper limit of content is 0.500% or less. A lower limit of Sn content is not particularly limited. The Sn content is preferably 0.002% or more. The Sn content is more preferably 0.005% or more. Further, the Sn content is preferably 0.300% or less.

### Sb: 0.200% or Less

Sb is an element that segregates at grain boundaries and acts to increase high-temperature strength. However, when content exceeds 0.200%, Sb segregation occurs and cracking occurs during welding, and therefore an upper limit of Sb content is 0.200% or less. A lower limit of the Sb content is not particularly limited. The Sb content is preferably 0.002% or more. The Sb content is more preferably 0.005% or more. Further, the Sb content is preferably 0.100% or less.

### Ta: 0.100% or Less

Ta combines with C and N to improve toughness, and is therefore added as required. However, when more than 0.100% is added, the effect is saturated and production costs increase, and therefore an upper limit of content is 0.100%. A lower limit of Ta content is not particularly limited. The Ta content is preferably 0.002% or more. The Ta content is more preferably 0.005% or more. Further, the Ta content is preferably 0.080% or less.

### Ca: 0.0050% or Less, Mg: 0.0050% or Less, Zr: 0.0050% or Less, Rare Earth Metal (REM): 0.0050% or Less

Ca, Mg, Zr, and REM are effective elements for spheroidizing the shape of sulfides and mitigating the adverse effects of sulfides on formability. When any of these elements are added, the content of each element is preferably 0.0005% or more. However, when the content of any of these elements is excessive, inclusions and the like may increase and surface and internal defects may occur. Therefore, when any of these elements are added, the content of each element is 0.0050% or less. Lower limits of content for each of these elements are not particularly limited. The content of each element is preferably 0.0002% or more. The content of each element is more preferably 0.0005% or more. Further, the content of each element is preferably 0.0035% or less.

### [Annealing Apparatus]

### [Annealing Process]

Annealing may be applied to the cold-rolled steel sheet and the hot-rolled steel sheet described above. That is, the steel sheet production system may include an annealing apparatus that applies annealing to the cold-rolled steel sheet and the hot-rolled steel sheet. The timing of annealing is not particularly limited. Hydrogen typically enters steel during an annealing process, and therefore annealing before applying a steady magnetic field is preferable in order to finally obtain a steel sheet having excellent hydrogen embrittlement resistance. The annealing apparatus may be a batch annealing furnace or a continuous annealing line.

### [Batch Annealing]

When an annealing process is performed using a batch annealing furnace, the steel sheet production system includes a batch annealing furnace that batch anneals the cold-rolled coil or the hot-rolled coil to obtain an annealed coil, and the dehydrogenation apparatus 300a that treats the annealed coil as the steel sheet coil C. The batch annealing furnaces applies batch annealing to the cold-rolled coil or the hot-rolled coil to obtain the annealed coil. Hereinafter, batch annealing means heating and holding in a batch annealing furnace and does not include slow cooling after heating and holding. After annealing, the annealed coil is cooled by furnace cooling in the batch annealing furnace, air cooling, or the like. The dehydrogenation apparatus 300a, with the annealed coil as the steel sheet coil C, applies a steady magnetic field to the steel sheet coil C under the conditions described above. The dehydrogenation apparatus 300a may be separate from the batch annealing furnace, or the housing 80 and the heater of the dehydrogenation apparatus 300a may also serve as the batch annealing furnace. In other words, the dehydrogenation apparatus 300a may be configured by providing the batch annealing furnace with the magnetic field applying apparatus 60 that applies a steady magnetic field to the steel sheet coil C in the furnace to obtain a product coil. When the housing 80 and the heater of the dehydrogenation apparatus 300a also serve as the batch annealing furnace, a steady magnetic field may be applied after the annealed coil is cooled to room temperature after batch annealing, or a steady magnetic field may be applied while cooling the annealed coil. As mentioned above, the higher the temperature of the steel sheet, the more efficiently diffusible hydrogen content can be decreased, and therefore a steady magnetic field can be applied after the annealed coil is cooled to room temperature after batch annealing, but by applying a steady magnetic field while cooling the annealed coil, diffusible hydrogen content in the steel may be decreased more efficiently.

When the annealing process is performed using the batch annealing furnace, the method of producing a steel sheet includes a process of applying batch annealing to a cold-rolled coil or a hot-rolled coil obtained by coiling a cold-rolled steel sheet or a hot-rolled steel sheet to obtain an annealed coil, and applying a steady magnetic field to the annealed coil as the steel sheet coil under the conditions described above. First, the cold-rolled steel sheet or the hot-rolled steel sheet is coiled by a known method to obtain the cold-rolled coil or the hot-rolled coil. The cold-rolled coil or the hot-rolled coil is then placed in the batch annealing furnace and batch annealing is applied in the batch annealing furnace to obtain the annealed coil. After annealing, the annealed coil is cooled by furnace cooling in the batch annealing furnace, air cooling, or the like. Next, a steady magnetic field is applied to the annealed coil under the conditions described above. The application of a steady magnetic field to the annealed coil may be performed during the batch annealing, that is, while the cold-rolled coil or the hot-rolled coil is being heated and held. Further, the application of a steady magnetic field may be performed after the batch annealing, that is, after the cold-rolled coil or the hot-rolled coil is heated and held. The application of a steady magnetic field may be performed after the batch annealing, after the annealed coil has cooled to room temperature. The application of a steady magnetic field may be performed after the batch annealing, while the annealed coil is cooling. As mentioned above, the higher the temperature of the steel sheet, the more efficiently diffusible hydrogen content can be decreased, and therefore a steady magnetic field is preferably applied to the annealed coil while cooling the annealed coil during or after the batch annealing. The application of a steady magnetic field to the annealed coil can be performed in the batch annealing furnace and can be performed after the annealed coil is removed from the batch annealing furnace. Preferably, a steady magnetic field is applied to the annealed coil in the batch annealing furnace. By applying a steady magnetic field to the annealed coil in the batch annealing furnace, diffusible hydrogen content in the steel may be efficiently decreased.

### [Annealing by Continuous Annealing Line]

Annealing can also be performed while passing a cold-rolled steel sheet or a hot-rolled steel sheet through a continuous annealing line (CAL). When the annealing process is performed using a continuous annealing line, the steel sheet production system includes a pre-annealing payoff apparatus that uncoil a cold-rolled coil or a hot-rolled coil to feed a cold-rolled steel sheet or a hot-rolled steel sheet, a continuous annealing furnace that continuously anneals the cold-rolled steel sheet or the hot-rolled steel sheet to produce an annealed steel sheet, an annealed steel sheet coiling apparatus, and the dehydrogenation apparatus 300a that treats the annealed coil as the steel sheet coil C. The pre-annealing payoff apparatus uncoils the cold-rolled coil or the hot-rolled coil and feeds the cold-rolled steel sheet or the hot-rolled steel sheet to the CAL. Configuration of the CAL is not particularly limited. As one example, the CAL includes a continuous annealing furnace in which a heating zone, a soaking zone, and a cooling zone are arranged in this order. The cooling zone may consist of multiple cooling zones, in which case a portion of the cooling zones may be holding zones that hold the cold-rolled steel sheet in the cooling process within a certain temperature range, or reheating zones that reheat the steel sheet in the cooling process. Further, a preheating zone may be upstream of a heating zone in the sheet passing direction. The pre-annealing payoff apparatus may be a payoff reel disposed upstream of the continuous annealing furnace of the CAL. The annealed steel sheet coiling apparatus may be a tension reel installed downstream of the continuous annealing furnace of the CAL. In the CAL, (A) a cold-rolled steel sheet or a hot-rolled steel sheet uncoiled and fed out from a cold-rolled coil or a hot-rolled coil by a payoff reel is (B) subjected to continuous annealing by being passed into a continuous annealing furnace where a heating zone, a soaking zone, and a cooling zone are disposed in this order from upstream in the sheet passing direction, (B-1) the cold-rolled steel sheet or the hot-rolled steel sheet is annealed in the heating zone and the soaking zone to obtain an annealed steel sheet, (B-2) the annealed steel sheet is cooled in the cooling zone, (C) the annealed steel sheet discharged from the continuous annealing furnace continues to be passed, and (D) the steel sheet is coiled by a tension reel to obtain an annealed coil. The dehydrogenation apparatus 300a applies a steady magnetic field to the annealed coil under the conditions described above, with the annealed coil as the steel sheet coil C. The application of a steady magnetic field decreases diffusible hydrogen content in the steel to obtain an annealed steel sheet having excellent hydrogen embrittlement resistance. The cooling method and cooling rate of a steel sheet in the cooling zone are not particularly limited, and any cooling such as gas jet cooling, mist cooling, or water cooling may be used.

When the annealing process is performed using the continuous annealing line, the method of producing a steel sheet includes a process of uncoiling a cold-rolled coil to feed a cold-rolled steel sheet, a process of continuously annealing the cold-rolled steel sheet to obtain an annealed steel sheet, and a process of coiling the annealed steel sheet to obtain an annealed coil, with the annealed coil as the steel sheet coil. In the CAL, (A) the steel sheet coil is uncoiled and fed out by the payoff reel, (B) continuous annealing is performed by passing the steel sheet into the annealing furnace where the heating zone, the soaking zone, and the cooling zone are disposed in this order from upstream in the sheet passing direction, (B-1) the steel sheet is annealed in the heating zone and the soaking zone, and (B-2) the steel sheet is cooled in the cooling zone, then (C) the steel sheet discharged from the annealing furnace continues to be passed, and (D) the steel sheet is coiled by the tension reel to obtain an annealed coil. By applying a steady magnetic field to the annealed coil under the conditions described above, a cold-rolled steel sheet or a hot-rolled steel sheet having excellent hydrogen embrittlement resistance may be obtained.

### [Coated or Plated Steel Sheet]

Further, the dehydrogenation apparatus 300a according to the present embodiment can also be applied to the production of a coated or plated steel sheet. The steel sheet production system for the present application example includes a coating or plating apparatus that forms a coating or plating on a surface of a hot-rolled steel sheet or a cold-rolled steel sheet to obtain a coated or plated steel sheet, a coated or plated steel sheet coiling apparatus that coils the coated or plated steel sheet to obtain a coated or plated steel sheet coil, and the dehydrogenation apparatus 300a that treats the coated or plated steel sheet coil as the steel sheet coil C. The coating or plating apparatus uses a hot-rolled steel sheet or a cold-rolled steel sheet as a base steel sheet and forms a coating or plating on a surface to obtain a coated or plated steel sheet. The coated or plated steel sheet coiling apparatus coils the coated or plated steel sheet to obtain the coated or plated steel sheet coil. The dehydrogenation apparatus 300a applies a steady magnetic field to the coated or plated steel sheet coil under the conditions described above, with the coated or plated steel sheet coil as the steel sheet coil C. The application of a steady magnetic field decreases diffusible hydrogen content in the steel to obtain a coated or plated steel sheet having excellent hydrogen embrittlement resistance.

Further, with a hot-rolled steel sheet or a cold-rolled steel sheet as the base steel sheet, a coating or plating may be formed on a surface to obtain a coated or plated steel sheet, and a steady magnetic field may be applied to the coated or plated steel sheet as a steel sheet coil. When a steady magnetic field is applied to a coated or plated steel sheet coil, the method of producing a steel sheet includes a process of forming a coating or plating on a surface of a hot-rolled steel sheet or a cold-rolled steel sheet to obtain a coated or plated steel sheet, and a process of coiling the coated or plated steel sheet to obtain a coated or plated steel sheet coil, with the coated or plated steel sheet coil as the steel sheet coil.

### [Forming Coating or Plating by Continuous Hot-Dip Galvanizing Line]

The type of coating or plating apparatus is not particularly limited, and may be, for example, a hot-dip galvanizing apparatus. The hot-dip galvanizing apparatus may be a continuous hot-dip galvanizing line (CGL), as one example. Configuration of the CGL is not particularly limited, but as one example, the CGL includes a continuous annealing furnace in which a heating zone, a soaking zone, and a cooling zone are arranged in this order, and a hot-dip galvanizing line disposed after the cooling zone. In the CGL, (A) a cold-rolled coil or a hot-rolled coil is uncoiled to feed a cold-rolled steel sheet or a hot-rolled steel sheet by a payoff reel, then the cold-rolled sheet or the hot-rolled steel sheet is (B) subjected to continuous annealing by being passed into a continuous annealing furnace where a heating zone, a soaking zone, and a cooling zone are disposed in this order from upstream in the sheet passing direction, in which (B-1) the hot-rolled steel sheet or the cold-rolled steel sheet is annealed in the soaking zone in a reducing atmosphere including hydrogen to obtain an annealed steel sheet, and (B-2) the annealed steel sheet is cooled in the cooling zone, after which (C) the annealed steel sheet discharged from the annealing furnace continues to be passed, (C-1) the annealed steel sheet is dipped in a hot-dip galvanizing bath disposed downstream of the continuous annealing furnace in the sheet passing direction to apply hot-dip galvanizing treatment and obtain a hot-dip galvanized steel sheet, and (D) the hot-dip galvanized steel sheet is coiled by a tension reel to obtain a hot-dip galvanized steel sheet coil. The dehydrogenation apparatus 300a applies a steady magnetic field to the hot-dip galvanized steel sheet coil under the conditions described above, with the hot-dip galvanized steel sheet coil as the steel sheet coil C. The application of a steady magnetic field decreases diffusible hydrogen content in the steel to obtain a hot-dip galvanized steel sheet having excellent hydrogen embrittlement resistance.

The method of forming a coating or plating on a surface of a hot-rolled steel sheet or a cold-rolled steel sheet is not particularly limited. The coating or plating process may include a hot-dip galvanizing process. That is, a hot-rolled steel sheet or a cold-rolled steel sheet may be subjected to a hot-dip galvanizing treatment to obtain a hot-dip galvanized steel sheet. As one example, a hot-dip galvanizing treatment may be applied to a steel sheet using a continuous hot-dip galvanizing line (CGL). In the CGL, a steel sheet coil is (A) uncoiled and fed out by a payoff reel, (B) continuous annealing is performed by a hot-rolled steel sheet or a cold-rolled steel sheet being passed into an annealing furnace where a heating zone, a soaking zone, and a cooling zone are disposed in this from upstream in the sheet passing direction, (B-1) the hot-rolled steel sheet or the cold-rolled steel sheet is annealed in the soaking zone in a reducing atmosphere including hydrogen to obtain an annealed steel sheet, and (B-2) the annealed steel sheet is cooled in the cooling zone, after which (C) the annealed steel sheet discharged from the annealing furnace continues to be passed, (D) the annealed steel sheet is coiled by a tension reel to form an annealed coil, and process (C) includes (C-1) dipping the annealed steel sheet into a hot-dip galvanizing bath disposed downstream of the annealing furnace in the sheet passing direction and applying a hot-dip galvanizing treatment to the annealed steel sheet. The coiled annealed coil is a hot-dip galvanized steel sheet coil made from a hot-dip galvanized steel sheet. By applying a steady magnetic field to the hot-dip galvanized steel sheet coil under the conditions described above, a hot-dip galvanized steel sheet having excellent hydrogen embrittlement resistance may be obtained.

Further, the coating or plating apparatus may include a hot-dip galvanizing apparatus and a subsequent alloying furnace. As one example, after producing a hot-dip galvanized steel sheet using the CGL, following process (C-1) described above, (C-2) the steel sheet is passed to an alloying furnace disposed downstream of the hot-dip galvanizing bath in the sheet passing direction to heat alloy the hot-dip galvanized coating. The galvannealed steel sheet passed through and alloyed by the alloying furnace is coiled to form a galvannealed steel sheet coil. The dehydrogenation apparatus 300a applies a steady magnetic field to the galvannealed steel sheet coil under the conditions described above, with the alloyed hot-dip galvanized steel sheet coil as the steel sheet coil C. By applying a steady magnetic field, a galvannealed steel sheet having excellent hydrogen embrittlement resistance may be obtained.

Further, the coating or plating process may include a hot-dip galvanizing process followed by an alloying process. That is, the hot-dip galvanized steel sheet may be further subjected to an alloying treatment to obtain a galvannealed steel sheet, and a steady magnetic field may be applied to the hot-dip galvanized steel sheet. As one example, after producing a hot-dip galvanized steel sheet using the CGL, following process (C-1) described above, (C-2) the steel sheet is passed to an alloying furnace disposed downstream of the hot-dip galvanizing bath in the sheet passing direction to heat alloy the hot-dip galvanized coating. The galvannealed steel sheet passed through and alloyed by the alloying furnace is coiled to form a galvannealed steel sheet coil. By applying a steady magnetic field to the galvannealed steel sheet coil under the conditions described above, a galvannealed steel sheet having excellent hydrogen embrittlement resistance may be obtained.

Further, other than hot-dip galvanized coating or plating, the coating or plating apparatus may form an Al coating or plating or an Fe coating or plating. Further, the coating or plating apparatus is not limited to a hot-dip coating apparatus, and may be an electroplating apparatus.

Further, the type of coating or plating that can be formed on a surface of a steel sheet to which a steady magnetic field is applied is not particularly limited, and may be an Al coating or plating or an Fe coating or plating. The method of forming a coating or plating is not limited to a hot-dip coating process, and may be an electroplating process.

The steel sheet production system may further include a skin pass rolling apparatus that performs skin pass rolling on a hot-rolled steel sheet, a cold-rolled steel sheet, or a coated or plated steel sheet with any type of coating or plating on a surface of a hot-rolled steel sheet or a cold-rolled steel sheet obtained as described above for a purpose such as shape adjustment or adjustment of roughness on a sheet surface. That is, according to the method of producing a steel sheet, skin pass rolling may be performed on a hot-rolled steel sheet, a cold-rolled steel sheet, or a coated or plated steel sheet with any type of coating or plating on a surface of a hot-rolled steel sheet or a cold-rolled steel sheet as described above for a purpose such as shape adjustment or adjustment of roughness on a sheet surface. Rolling reduction of the skin pass rolling is preferably 0.1% or more. Rolling reduction of the skin pass rolling is preferably 2.0% or less. By setting the rolling reduction of the skin pass rolling to 0.1% or more, the effects of shape adjustment and adjustment of roughness on a sheet surface may be more suitably obtained, and control of rolling reduction is also more suitable. Further, productivity is better when the rolling reduction of the skin pass rolling is 2.0% or less. The skin pass rolling apparatus may be continuous with a CGL or a CAL (in-line) or discontinuous with a CGL or a CAL (off-line). Skin pass rolling to a target rolling reduction may be performed in one pass, or skin pass rolling may be performed in a plurality of passes to achieve a target rolling reduction. Further, the steel sheet production system may further include a coating apparatus to apply any of various coating treatments such as resin or oil coating to a surface of a hot-rolled steel sheet, a cold-rolled steel sheet, or a coated or plated steel sheet with any type of coating or plating on a surface of a hot-rolled steel sheet or a cold-rolled steel sheet obtained as described above. That is, any of various coating treatments such as resin or oil coating may be applied to a surface of a hot-rolled steel sheet, a cold-rolled steel sheet, or a coated or plated steel sheet with any type of coating or plating on a surface of a hot-rolled steel sheet or a cold-rolled steel sheet obtained as described above.

### Embodiment 2

The dehydrogenation apparatus according to Embodiment 2 of the present disclosure includes a payoff apparatus that uncoils a steel sheet coil to feed a steel strip, a sheet passing apparatus that passes the steel strip, a coiling apparatus that coils the steel strip, and a magnetic field applying apparatus that applies a steady magnetic field along the sheet transverse direction of the steel strip to the steel strip being passed.

Further, the method of producing a steel sheet according to Embodiment 2 of the present disclosure includes a process of uncoiling a steel sheet coil to feed a steel strip, a sheet passing process of passing the steel strip, and a process of coiling the steel strip into a product coil, where the sheet passing process includes a magnetic field applying process of applying a steady magnetic field to the steel strip along the sheet transverse direction of the steel strip.

After hot rolling or cold rolling, the steel sheet is optionally annealed, or further coated or plated to form a coated or plated steel sheet, and then coiled into a coil to obtain a steel sheet coil. Mass of the steel sheet coil is often different from packing mass of a shipment, and therefore division into packing mass is performed on a recoiling line. The steel strip is uncoiled from the steel sheet coil by a payoff apparatus, and the uncoiled steel strip is recoiled by a recoiling apparatus and sheared and divided upon reaching a defined packing mass. According to the present embodiment, a steady magnetic field is applied to the steel strip uncoiled and fed out by the recoiling line. According to the present embodiment, a steady magnetic field is applied to the steel strip being passed, and therefore a steady magnetic field can be applied evenly over the entire length of the steel strip. The dehydrogenation apparatus according to the present embodiment is discontinuous (off-line) from a continuous annealing line or a continuous hot-dip galvanizing line, and the dehydrogenation apparatus does not include facilities for annealing, coating or plating treatment, or hot-dip galvanizing treatment of the steel strip.

### (Magnetic Field Applying Apparatus 60)

A magnetic field applying apparatus can be used to apply a steady magnetic field. As an example, the magnetic field applying apparatus applies a steady magnetic field along the sheet transverse direction of the steel strip being passed, similar to the magnetic field applying apparatus 60 according to Embodiment 1 described above. Configuration of the magnetic field applying apparatus 60 can be the same as that of Embodiment 1, except that the object to which a steady magnetic field is applied is a steel strip being passed instead of a steel sheet coil.

### [Dehydrogenation Apparatus]

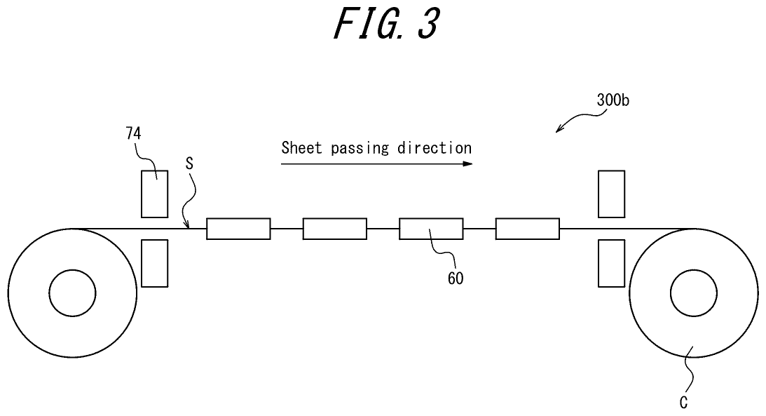

FIG. 3 illustrates a view of a dehydrogenation apparatus 300b used in the method of producing a steel sheet according to the present embodiment, viewed along the transverse direction of a steel strip S. FIG. 3 illustrates an example of a dehydrogenation apparatus for decreasing diffusible hydrogen content in steel by applying a steady magnetic field to the steel strip S being passed, by using the magnetic field applying apparatus 60. As illustrated in FIG. 3, according to the dehydrogenation apparatus 300b, the magnetic field applying apparatus 60 is disposed in the sheet passing process of the steel strip S uncoiled and fed out by the payoff apparatus. Although not illustrated, each of the magnetic field applying apparatus 60 includes the electromagnets 60A, 60B, which respectively include the iron cores 62A, 62B, the coils 64A, 64B wound around the iron cores 62A, 62B, and a driving power source (not illustrated) to pass current through the coils 64A, 64B. Further, although not illustrated, the dehydrogenation apparatus 300b includes a sheet passing apparatus to pass the steel strip S from the payoff apparatus to the coiling apparatus. The sheet passing apparatus includes, for example, a sheet passing roller that passes the steel strip S toward the coiling apparatus.

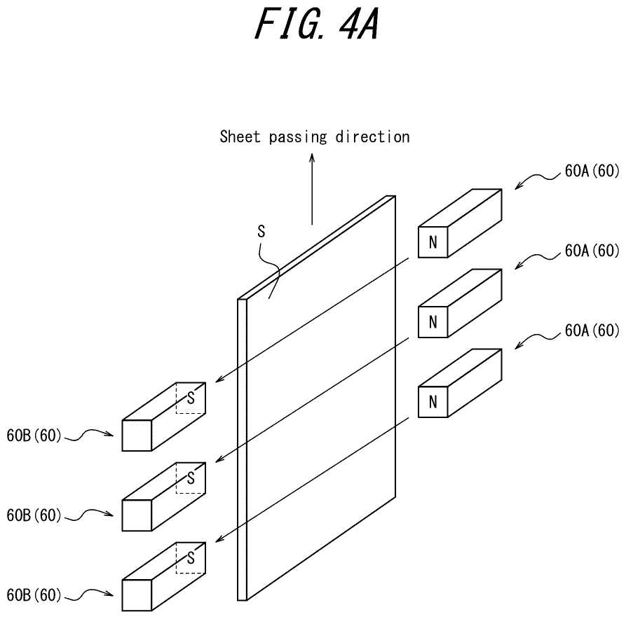

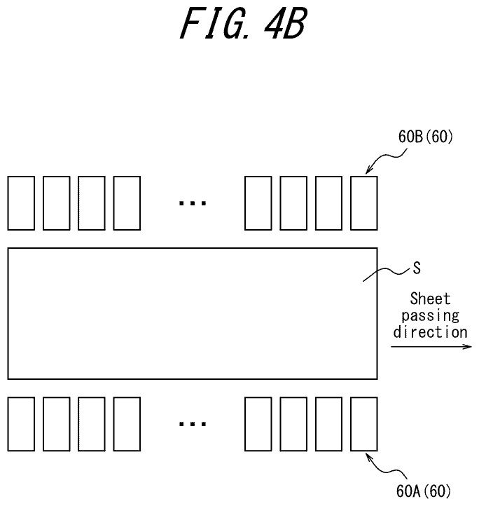

The pair of the magnetic pole faces 66A, 66B of the magnetic field applying apparatus 60 are preferably at the same position along the sheet passing direction of the steel strip S and oppose each other across the steel strip being passed. Accordingly, as illustrated in FIG. 4A, a steady magnetic field generated by the pair of the electromagnets 60A, 60B has a main flux going from the magnetic pole face 66A (N pole) to the magnetic pole face 66B (S pole), the direction of which matches the sheet transverse direction of the steel strip being passed. This allows the application of a uniform steady magnetic field along the sheet transverse direction of the steel strip being passed. As illustrated in FIG. 4A and FIG. 4B, by arranging a plurality of such pairs of the electromagnets 60A, 60B along the sheet passing direction, sufficient time may be secured to apply a magnetic field to the steel strip being passed. The magnetic field applying apparatus 60 may be configured to include only the electromagnet 60A or only the electromagnet 60B. When the magnetic field formed by one of the electromagnets is strong enough to apply a magnetic field along the sheet transverse direction to the entire width of the steel strip being passed, a configuration including only one of the electromagnets may be used.

A structure for holding the electromagnets 60A, 60B at regular intervals in the dehydrogenation apparatus 300B is not particularly limited. For example, a box-shaped section may be provided in the sheet passing path to surround the steel strip S being passed, and the electromagnets 60 may be fixed at regular intervals on an inner wall of the box-shaped section.

According to the present embodiment, magnetic flux density of a magnetic field applied to the steel strip being passed can be the same as that of Embodiment 1.

### [Magnetic Field Application Time]

Unlike in a continuous annealing line or a continuous hot-dip galvanizing line, there is no need to adjust sheet passing speed in a recoiling line to match annealing time. Therefore, according to the present embodiment, a steady magnetic field may be applied to the steel strip without any restriction on application time. It may be presumed that the longer a steady magnetic field is applied, the more diffusible hydrogen content can be decreased, and therefore the application time of a steady magnetic field is preferably 0.5 min or more. The application time of a steady magnetic field is more preferably 30 min or more. The application time of a steady magnetic field is even more preferably 60 min or more. On the other hand, from the viewpoint of productivity, the application time of a steady magnetic field is preferably 30,000 min or less. The application time of a steady magnetic field is more preferably 10,000 min or less. The application time of a steady magnetic field is even more preferably 1000 min or less. The application time of the steady magnetic field can be adjusted according to the sheet passing speed of the steel strip S and the number and disposition of the magnetic field applying apparatus 60 (for example, the number and disposition of a plurality of the magnetic field applying apparatus disposed along the sheet passing direction).

According to the present embodiment, the diffusible hydrogen content in a product coil obtained after magnetic field application may be decreased to 0.50 mass ppm or less. By decreasing the diffusible hydrogen content in the product coil to 0.50 mass ppm or less, hydrogen embrittlement may be prevented. The diffusible hydrogen content in the steel after magnetic field application is preferably 0.30 mass ppm or less. The diffusible hydrogen content in the steel after magnetic field application is even more preferably 0.20 mass ppm or less. The diffusible hydrogen content in the steel after magnetic field application can be measured as described for Embodiment 1.

### [Heating Apparatus]

### [Steel Strip Holding Temperature]

Further, as illustrated in FIG. 3, the dehydrogenation apparatus 300b may further include a heating apparatus 74 for heating the steel strip S to 300° C. or less while a steady magnetic field is applied. The temperature of the steel strip S in the magnetic field applying process is not particularly limited. According to the present embodiment, diffusible hydrogen content in steel may be decreased without heating and holding the temperature of the steel strip S. However, by heating the steel strip S by the heating apparatus while a steady magnetic field is applied, the diffusion rate of hydrogen may be increased, and diffusible hydrogen content in steel may be further decreased. Accordingly, the temperature of the steel strip S when applying a steady magnetic field is preferably 30° C. or more. The temperature of the steel strip S when applying a steady magnetic field is more preferably 50° C. or more. The temperature of the steel strip S when applying a steady magnetic field is even more preferably 100° C. or more. An upper limit of the temperature of the steel strip S in the magnetic field applying process is not particularly limited. From the viewpoint of suitably preventing microstructural changes in the steel strip S, the temperature is preferably set at 300° C. or less. According to the present embodiment, the temperature of the steel strip S when a steady magnetic field is applied is based on the temperature of a surface of the steel strip S. Surface temperature of the steel strip can be measured by a typical radiation thermometer. Structure of the heating apparatus 74 is not particularly limited. For example, as illustrated in FIG. 3, the heating apparatus 74 may be disposed on the sheet passing path of the steel strip S. By disposing the heating apparatus 74 on the sheet passing path of the steel strip S, the steel strip S may be evenly heated. When the heating apparatus 74 is disposed on the sheet passing path of the steel strip S, the heating apparatus 74 is preferably disposed upstream of the magnetic field applying apparatus 60 along the sheet passing path, as illustrated in FIG. 3. By disposing the heating apparatus 74 upstream of the magnetic field applying apparatus 60 along the sheet passing path, a steady magnetic field can be applied to a sufficiently heated steel strip S. Further, for example, by surrounding the steel strip being passed with the box-shaped section described above and disposing heaters on the side walls of the box-shaped section, a steady magnetic field can be applied while heating and holding temperature of the steel strip S. Further, a method of blowing hot air generated outside and circulating the hot air inside the box-shaped section can also be used to apply a steady magnetic field while heating and holding temperature of the steel strip S. The heating method is not particularly limited and may be a combustion method or an electric method. As an example, the heating apparatus 74 may be an induction heating device.

The dehydrogenation apparatus 300b according to the present embodiment may further include a magnetic field blocker to prevent the steady magnetic field from being transmitted outside the dehydrogenation apparatus 300b. Specific configuration of the magnetic field blocker is not particularly limited. The magnetic field blocker may be, for example, a magnetic field blocking material that surrounds the steel strip S and the electromagnets 60A, 60B.

The following is a more specific explanation of application of the present embodiment.

### [Hot-Rolled Steel Sheet]

As with Embodiment 1, the dehydrogenation apparatus 300b and the method of producing a steel sheet according to the present embodiment can be applied to the production of a hot-rolled steel sheet.

The steel sheet production system for the present application example includes a hot rolling apparatus that hot rolls a steel slab to obtain a hot-rolled steel sheet, a hot-rolled steel sheet coiling apparatus that coils the hot-rolled steel sheet to obtain a hot-rolled coil, and the steel sheet dehydrogenation apparatus 300b that treats the hot-rolled coil as the steel sheet coil. The hot-rolled coil produced by a known hot-rolling apparatus is uncoiled to feed and pass through the hot rolled steel sheet, and a steady magnetic field is applied to the hot-rolled steel sheet being passed under the conditions described above to decrease the diffusible hydrogen content in the steel and to obtain a hot-rolled steel sheet having excellent hydrogen embrittlement resistance.

As with Embodiment 1, the method of producing a steel sheet according to the present embodiment can be applied to the production of a hot-rolled steel sheet. The method of producing a steel sheet according to the present application example includes a process of hot rolling a steel slab to obtain a hot-rolled steel sheet and a process of coiling the hot-rolled steel sheet to obtain a hot-rolled coil, with the hot-rolled coil as the steel sheet coil. The method of producing a hot-rolled coil before application of a steady magnetic field is not particularly limited, and may be, for example, the production method illustrated in Embodiment 1. The hot-rolled coil is uncoiled to feed and pass through the hot-rolled steel sheet, and a steady magnetic field is applied to the hot-rolled steel sheet being passed under the conditions described above to decrease the diffusible hydrogen content in the steel and to obtain a hot-rolled steel sheet having excellent hydrogen embrittlement resistance.

### [Cold-Rolled Steel Sheet]

The dehydrogenation apparatus 300b and the method of producing a steel sheet according to the present embodiment can also be applied to the production of a cold-rolled steel sheet.

The steel sheet production system for the present application example includes a cold rolling apparatus that cold rolls a hot-rolled steel sheet to obtain a cold-rolled steel sheet, a cold-rolled steel sheet coiling apparatus that coils the cold-rolled steel sheet to obtain a cold-rolled coil, and the dehydrogenation apparatus 300b that treats the cold-rolled coil as the steel sheet coil C. A known hot-rolled steel sheet is subjected to cold rolling by a known cold rolling apparatus to obtain a cold-rolled steel sheet. A cold-rolled steel sheet coiling apparatus coils the cold-rolled steel sheet to obtain a cold-rolled coil. With the cold-rolled coil as the steel sheet coil C, the cold-rolled coil is uncoiled to feed and pass through the cold-rolled steel sheet, and a steady magnetic field is applied to the cold-rolled steel sheet being passed under the conditions described above to decrease the diffusible hydrogen content in the steel and to obtain a cold-rolled steel sheet having excellent hydrogen embrittlement resistance.

The method of producing a steel sheet according to the present application example includes a process of cold rolling a hot-rolled steel sheet to obtain a cold-rolled steel sheet and a process of coiling the cold-rolled steel sheet to obtain a cold-rolled coil, with the cold-rolled coil as the steel sheet coil. The method of producing a cold-rolled coil before application of a steady magnetic field is not particularly limited, and may be, for example, the production method illustrated in Embodiment 1. The cold-rolled coil is uncoiled to feed and pass through the cold-rolled steel sheet, and a steady magnetic field is applied to the cold-rolled steel sheet being passed under the conditions described above to decrease the diffusible hydrogen content in the steel and to obtain a cold-rolled steel sheet having excellent hydrogen embrittlement resistance.

The chemical composition of a hot-rolled steel sheet or a cold-rolled steel sheet to which a steady magnetic field is applied by the dehydrogenation apparatus 300b is not limited. According to the present embodiment, the dehydrogenation apparatus 300b applies a steady magnetic field to a high strength steel sheet having a tensile strength of 590 MPa or more, more preferably 1180 MPa or more, and even more preferably 1470 MPa or more, thereby decreasing diffusible hydrogen content in the steel to obtain a high strength steel sheet having excellent hydrogen embrittlement resistance.

The chemical composition of a hot-rolled steel sheet or a cold-rolled steel sheet may be, for example, the chemical composition exemplified in Embodiment 1.

### [Annealing Apparatus]

As with Embodiment 1, the steel sheet production system may include an annealing apparatus that applies annealing to the cold-rolled steel sheet and the hot-rolled steel sheet. The timing of annealing is not particularly limited. Hydrogen typically enters steel during an annealing process, and therefore annealing before applying a steady magnetic field is preferable in order to finally obtain a steel sheet having excellent hydrogen embrittlement resistance. The annealing apparatus may be a batch annealing furnace or a continuous annealing line.

### [Annealing Process]

As with Embodiment 1, annealing may be applied to the cold-rolled steel sheet and the hot-rolled steel sheet described above. The timing of annealing is not particularly limited. Annealing is preferably applied before the magnetic field applying process. The annealing process can be performed by a batch annealing furnace or by a continuous annealing line.

### [Batch Annealing]

When an annealing process is performed using a batch annealing furnace, the steel sheet production system includes a batch annealing furnace that batch anneals the cold-rolled coil or the hot-rolled coil to obtain an annealed coil, and the dehydrogenation apparatus 300b that treats the annealed coil as the steel sheet coil C. After annealing, the annealed coil is cooled by furnace cooling in the batch annealing furnace, air cooling, or the like. The payoff apparatus uncoils annealed coil to feed the annealed steel sheet to the sheet passing apparatus, which then passes the annealed steel sheet. The magnetic field applying apparatus 60 applies a steady magnetic field to the annealed steel sheet being passed, under the conditions described above. The application of a magnetic field decreases diffusible hydrogen content in the steel to obtain an annealed steel sheet having excellent hydrogen embrittlement resistance.

When the annealing process is performed using the batch annealing furnace, the method of producing a steel sheet includes a process of coiling a cold-rolled steel sheet or a hot-rolled steel sheet into a cold-rolled or a hot-rolled coil and applying batch annealing to the cold-rolled or the hot-rolled coil to obtain an annealed coil, with the annealed coil as the steel sheet coil. After annealing, the annealed coil is cooled by furnace cooling in the batch annealing furnace, air cooling, or the like. The annealed coil is uncoiled to feed and pass through the annealed steel sheet, and a steady magnetic field is applied to the annealed steel sheet being passed under the conditions described above to decrease the diffusible hydrogen content in the steel and to obtain a hot-rolled steel sheet or a cold-rolled steel sheet having excellent hydrogen embrittlement resistance.

### [Annealing by Continuous Annealing Line]

Annealing can also be performed while passing a cold-rolled steel sheet or a hot-rolled steel sheet through a continuous annealing line (CAL). When the annealing process is performed using a continuous annealing line, the steel sheet production system includes a pre-annealing payoff apparatus that uncoils a cold-rolled coil or a hot-rolled coil to feed a cold-rolled steel sheet or a hot-rolled steel sheet, a continuous annealing furnace that continuously anneals the cold-rolled steel sheet or the hot-rolled steel sheet to produce an annealed steel sheet, an annealed steel sheet coiling apparatus, and the dehydrogenation apparatus 300b that treats the annealed coil as the steel sheet coil C. The configuration of the continuous annealing line is the same as that of Embodiment 1. The payoff apparatus of the dehydrogenation apparatus 300b uncoils the annealed coil to feed the annealed steel sheet to the sheet passing apparatus, which then passes the annealed steel sheet. The magnetic field applying apparatus 60 applies a steady magnetic field to the annealed steel sheet being passed, under the conditions described above. The application of a magnetic field decreases diffusible hydrogen content in the steel to obtain an annealed steel sheet having excellent hydrogen embrittlement resistance.

When the annealing process is performed using a continuous annealing line, the annealed coil prior to the application of a magnetic field can be produced in the same way as described for Embodiment 1. The annealed coil is uncoiled to feed the annealed steel strip, and a steady magnetic field is applied to the annealed steel sheet being passed under the conditions described above to obtain a cold-rolled steel sheet or a hot-rolled steel sheet having excellent hydrogen embrittlement resistance.

### [Coated or Plated Steel Sheet]

As with Embodiment 1, the dehydrogenation apparatus 300b and the method of producing a steel sheet according to the present embodiment can also be applied to the production of a coated or plated steel sheet.

The steel sheet production system for the present application example includes a coating or plating apparatus that forms a coating or plating on a surface of a hot-rolled steel sheet or a cold-rolled steel sheet to obtain a coated or plated steel sheet, a coated or plated steel sheet coiling apparatus that coils the coated or plated steel sheet to obtain a coated or plated steel sheet coil, and the dehydrogenation apparatus 300b that treats the coated or plated steel sheet coil as the steel sheet coil C. The type of coating or plating that can be formed on a surface of a hot-rolled steel sheet or a cold-rolled steel sheet is not particularly limited, and may be a galvanized coating or plating, an Al coating or plating, or a Fe coating or plating, for example. The method of forming a coating or plating is not limited to a hot-dip coating process, and may be an electroplating process.

Further, the method of producing a steel sheet according to the present application example includes a process of forming a coating or plating on a surface of a hot-rolled steel sheet or a cold-rolled steel sheet to obtain a coated or plated steel sheet, and a process of coiling the coated or plated steel sheet to obtain a coated or plated steel sheet coil, with the coated or plated steel sheet coil as the steel sheet coil.

### [Forming Coating or Plating by Continuous Hot-Dip Galvanizing Line]

The type of coating or plating apparatus is not particularly limited, and may be, for example, a hot-dip galvanizing apparatus. The hot-dip galvanizing apparatus may be a continuous hot-dip galvanizing line (CGL), as one example. The configuration of the CGL may be the same as that of Embodiment 1. The payoff apparatus of the dehydrogenation apparatus 300b uncoils a hot-dip galvanized steel sheet coil produced by the CGL to feed a hot-dip galvanized steel sheet to the sheet passing apparatus, and the sheet passing apparatus passes through the hot-dip galvanized steel sheet. The magnetic field applying apparatus 60 applies a steady magnetic field to the annealed steel sheet being passed, under the conditions described above. The application of a steady magnetic field decreases diffusible hydrogen content in the steel to obtain a hot-dip galvanized steel sheet having excellent hydrogen embrittlement resistance.

The steel sheet may be subjected to the hot-dip galvanizing treatment to obtain a hot-dip galvanized steel sheet before applying a steady magnetic field. As one example, a hot-dip galvanizing treatment may be applied to a steel strip using a continuous hot-dip galvanizing line (CGL). The configuration of the CGL may be the same as that of Embodiment 1. The hot-dip galvanized steel sheet coil before the application of a steady magnetic field may be produced in the same way described for Embodiment 1. The hot-dip galvanized steel sheet coil is uncoiled to feed and pass through the hot-dip galvanized steel sheet, and a steady magnetic field is applied to the hot-dip galvanized steel sheet being passed under the conditions described above to obtain a hot-dip galvanized steel sheet having excellent hydrogen embrittlement resistance.

Further, the coating or plating apparatus may include a hot-dip galvanizing apparatus and a subsequent alloying furnace. That is, in the method of producing a steel sheet, the coating or plating process may include a hot-dip galvanizing process followed by an alloying process. As a coating or plating apparatus including an alloying furnace, the CGL including an alloying furnace downstream of the hot-dip galvanizing bath in the sheet passing direction can be used, as exemplified in Embodiment 1. The galvannealed steel sheet coil formed by the hot-dip galvanizing process and the subsequent alloying process is uncoiled to feed the galvannealed steel sheet, and a steady magnetic field is applied to the galvannealed steel sheet under the conditions described above to obtain a galvannealed steel sheet having excellent hydrogen embrittlement resistance.

As with Embodiment 1, the steel sheet production system may further include a skin pass rolling apparatus that performs skin pass rolling on a hot-rolled steel sheet, a cold-rolled steel sheet, or a coated or plated steel sheet with any type of coating or plating on a surface of a hot-rolled steel sheet or a cold-rolled steel sheet obtained as described above for a purpose such as shape adjustment or adjustment of roughness on a sheet surface. Further, the steel sheet production system may further include a coating apparatus to apply any of various coating treatments such as resin or oil coating to a surface of a hot-rolled steel sheet, a cold-rolled steel sheet, or a coated or plated steel sheet with any type of coating or plating on a surface of a hot-rolled steel sheet or a cold-rolled steel sheet obtained as described above.

That is, according to the method of producing a steel sheet, skin pass rolling may be performed on a hot-rolled steel sheet, a cold-rolled steel sheet, or a coated or plated steel sheet with any type of coating or plating on a surface of a hot-rolled steel sheet or a cold-rolled steel sheet as described above, as described for Embodiment 1. Further, any of various coating treatments such as resin or oil coating may be applied to a surface of a hot-rolled steel sheet, a cold-rolled steel sheet, or a coated or plated steel sheet with any type of coating or plating on a surface of a hot-rolled steel sheet or a cold-rolled steel sheet obtained as described above.

### Examples

Steels having the chemical compositions listed in Table 1, each with the balance consisting of Fe and inevitable impurity, were prepared by steelmaking steel material in a converter and formed into steel slabs by continuous casting. The resulting steel slabs were cold rolled after hot rolling and further annealed to obtain cold-rolled steel sheets (CR). For some cold-rolled steel sheets, hot-dip galvanizing treatment was further applied to produce hot-dip galvanized steel sheets (GI). For some hot-dip galvanized steel sheets, further alloying treatment was performed to obtain galvannealed steel sheets (GA). CR, GI, and GA were all 1.4 mm thick and 1000 mm wide. The CAL used was a CAL in which a heating zone, a soaking zone, and a cooling zone were arranged in this order. The CGL used was a continuous annealing furnace in which a heating zone, a soaking zone, and a cooling zone are arranged in this order, and a hot-dip galvanizing line is disposed after the cooling zone. A typical batch annealing furnace was used as a batch annealing furnace.

TABLE 1

| Steel | Chemical composition (mass %) | | | | | | | | | | | | |
|---|---|---|---|---|---|---|---|---|---|---|---|---|---|
| sample ID | C | Si | Mn | P | S | N | Al | Ti | Nb | V | W | B | Ni |
| A | 0.222 | 1.49 | 2.74 | 0.019 | 0.0024 | 0.0035 | 0.027 | — | — | — | — | — | — |
| B | 0.171 | 1.48 | 2.25 | 0.024 | 0.0025 | 0.0039 | 0.048 | — | — | — | — | — | — |
| C | 0.165 | 0.58 | 3.52 | 0.015 | 0.0017 | 0.0023 | 0.032 | 0.048 | — | — | — | — | — |
| D | 0.784 | 0.94 | 1.27 | 0.033 | 0.0031 | 0.0023 | 0.060 | — | — | — | — | — | — |
| E | 0.046 | 0.99 | 3.09 | 0.029 | 0.0023 | 0.0026 | 0.030 | — | — | — | — | — | — |
| F | 0.171 | 2.91 | 3.22 | 0.027 | 0.0022 | 0.0030 | 0.030 | 0.022 | — | — | — | — | — |
| G | 0.421 | 0.63 | 1.11 | 0.033 | 0.0023 | 0.0033 | 0.037 | — | — | — | — | — | — |
| H | 0.068 | 1.05 | 5.01 | 0.024 | 0.0031 | 0.0034 | 0.046 | — | — | — | — | — | — |
| I | 0.239 | 2.04 | 2.87 | 0.019 | 0.0020 | 0.0022 | 0.034 | — | — | — | — | — | — |
| J | 0.147 | 0.20 | 3.42 | 0.028 | 0.0026 | 0.0033 | 0.032 | 0.010 | — | — | — | — | — |
| K | 0.112 | 0.33 | 7.01 | 0.026 | 0.0025 | 0.0032 | 0.031 | 0.052 | — | — | — | — | — |
| L | 0.339 | 0.46 | 0.63 | 0.024 | 0.0028 | 0.0028 | 0.031 | — | — | — | — | — | — |
| M | 0.167 | 0.36 | 1.87 | 0.024 | 0.0032 | 0.0031 | 1.053 | 0.045 | — | — | — | — | — |
| N | 0.187 | 0.37 | 1.79 | 0.030 | 0.0027 | 0.0042 | 0.045 | — | — | — | — | — | — |
| O | 0.151 | 0.77 | 3.41 | 0.017 | 0.0020 | 0.0039 | 0.041 | — | 0.040 | — | — | — | — |
| P | 0.132 | 0.53 | 2.53 | 0.030 | 0.0026 | 0.0040 | 0.045 | 0.017 | 0.042 | — | — | — | — |
| Q | 0.110 | 1.10 | 2.56 | 0.027 | 0.0022 | 0.0026 | 0.044 | 0.090 | — | 0.057 | — | — | — |
| R | 0.094 | 1.17 | 4.06 | 0.026 | 0.0027 | 0.0030 | 0.046 | — | — | — | 0.019 | — | — |
| S | 0.275 | 0.92 | 3.02 | 0.030 | 0.0025 | 0.0042 | 0.041 | 0.022 | — | — | — | 0.0022 | — |
| T | 0.176 | 0.66 | 6.41 | 0.025 | 0.0027 | 0.0038 | 0.012 | 0.101 | — | — | — | — | 0.108 |
| U | 0.100 | 0.12 | 2.30 | 0.023 | 0.0025 | 0.0039 | 0.060 | — | — | — | — | — | — |
| V | 0.108 | 1.41 | 3.09 | 0.028 | 0.0025 | 0.0034 | 0.034 | 0.029 | — | — | — | — | — |
| W | 0.164 | 1.54 | 2.75 | 0.028 | 0.0025 | 0.0029 | 0.042 | — | — | — | — | — | — |
| X | 0.127 | 0.54 | 3.14 | 0.028 | 0.0017 | 0.0029 | 0.034 | 0.043 | — | — | — | — | — |
| Y | 0.160 | 0.44 | 1.98 | 0.019 | 0.0018 | 0.0027 | 0.036 | 0.023 | — | — | — | — | — |
| Z | 0.143 | 0.66 | 3.58 | 0.018 | 0.0021 | 0.0033 | 0.031 | — | — | — | — | — | — |
| AA | 0.230 | 1.51 | 2.75 | 0.022 | 0.0025 | 0.0037 | 0.037 | — | — | — | — | — | — |
| AB | 0.173 | 0.99 | 2.82 | 0.018 | 0.0025 | 0.0036 | 0.037 | — | — | — | — | — | — |
| AC | 0.131 | 0.04 | 3.03 | 0.027 | 0.0023 | 0.0025 | 0.036 | 0.007 | — | — | — | — | — |
| AD | 0.068 | 0.05 | 7.10 | 0.024 | 0.0029 | 0.0036 | 0.039 | — | — | — | — | — | — |
| AE | 0.061 | 0.62 | 1.07 | 0.028 | 0.0079 | 0.0360 | 0.031 | — | — | — | — | — | 8.16 |
| AF | 0.058 | 0.69 | 0.89 | 0.026 | 0.0066 | 0.0310 | 0.037 | — | — | — | — | — | — |
| AG | 0.103 | 0.75 | 0.90 | 0.027 | 0.0070 | 0.0324 | 0.040 | — | — | — | — | — | — |
| AH | 0.019 | 0.64 | 0.95 | 0.030 | 0.0153 | 0.0202 | 0.043 | 0.389 | — | — | — | — | — |
| AI | 0.017 | 0.77 | 0.92 | 0.031 | 0.0151 | 0.0198 | 0.041 | 0.379 | — | — | — | — | — |
| AJ | 0.021 | 0.80 | 0.90 | 0.021 | 0.0137 | 0.0224 | 0.036 | 0.393 | 0.460 | — | — | — | — |

| Steel | Chemical composition (mass %) | | | | | | | | | | |
|---|---|---|---|---|---|---|---|---|---|---|---|
| sample ID | Cr | Mo | Cu | Sn | Sb | Ta | Ca | Mg | Zr | REM | Remarks |
| A | — | — | — | — | — | — | — | — | — | — | Disclosed |
| | | | | | | | | | | | steel |
| B | — | — | — | — | — | — | — | — | — | — | Disclosed |
| | | | | | | | | | | | steel |
| C | — | — | — | — | — | — | — | — | — | — | Disclosed |
| | | | | | | | | | | | steel |
| D | — | — | — | — | — | — | — | — | — | — | Disclosed |
| | | | | | | | | | | | steel |
| E | — | — | — | — | — | — | — | — | — | — | Disclosed |
| | | | | | | | | | | | steel |
| F | — | — | — | — | — | — | — | — | — | — | Disclosed |
| | | | | | | | | | | | steel |
| G | — | — | — | — | — | — | — | — | — | — | Disclosed |
| | | | | | | | | | | | steel |
| H | — | — | — | — | — | — | — | — | — | — | Disclosed |
| | | | | | | | | | | | steel |
| I | — | — | — | — | — | — | — | — | — | — | Disclosed |
| | | | | | | | | | | | steel |
| J | — | — | — | — | — | — | — | — | — | — | Disclosed |
| | | | | | | | | | | | steel |
| K | — | — | — | — | — | — | — | — | — | — | Disclosed |
| | | | | | | | | | | | steel |
| L | — | — | — | — | — | — | — | — | — | — | Disclosed |
| | | | | | | | | | | | steel |
| M | — | — | — | — | — | — | — | — | — | — | Disclosed |
| | | | | | | | | | | | steel |
| N | — | — | — | — | — | — | — | — | — | — | Disclosed |
| | | | | | | | | | | | steel |
| O | — | — | — | — | — | — | — | — | — | — | Disclosed |
| | | | | | | | | | | | steel |
| P | — | — | — | — | — | — | — | — | — | — | Disclosed |
| | | | | | | | | | | | steel |
| Q | — | — | — | — | — | — | — | — | — | — | Disclosed |
| | | | | | | | | | | | steel |
| R | — | — | — | — | — | — | — | — | — | — | Disclosed |
| | | | | | | | | | | | steel |
| S | — | — | — | — | — | — | — | — | — | — | Disclosed |
| | | | | | | | | | | | steel |
| T | — | — | — | — | — | — | — | — | — | — | Disclosed |
| | | | | | | | | | | | steel |
| U | 0.595 | — | — | — | — | — | — | — | — | — | Disclosed |
| | | | | | | | | | | | steel |
| V | — | 0.058 | — | — | — | — | — | — | — | — | Disclosed |
| | | | | | | | | | | | steel |
| W | — | — | 0.115 | — | — | — | — | — | — | — | Disclosed |
| | | | | | | | | | | | steel |
| X | — | — | — | 0.060 | — | — | — | — | — | — | Disclosed |
| | | | | | | | | | | | steel |
| Y | — | — | — | — | 0.080 | — | — | — | — | — | Disclosed |
| | | | | | | | | | | | steel |
| Z | — | — | — | — | — | 0.007 | — | — | — | — | Disclosed |
| | | | | | | | | | | | steel |
| AA | — | — | — | — | — | — | 0.0041 | — | — | — | Disclosed |
| | | | | | | | | | | | steel |
| AB | — | — | — | — | — | — | — | 0.0033 | — | — | Disclosed |
| | | | | | | | | | | | steel |
| AC | — | — | — | — | — | — | — | — | 0.0034 | — | Disclosed |
| | | | | | | | | | | | steel |
| AD | — | — | — | — | — | — | — | — | — | 0.0029 | Disclosed |
| | | | | | | | | | | | steel |
| AE | 18.21 | — | — | — | — | — | — | — | — | — | Disclosed |
| | | | | | | | | | | | steel |
| AF | 16.30 | — | — | — | — | — | — | — | — | — | Disclosed |
| | | | | | | | | | | | steel |
| AG | 12.91 | — | — | — | — | — | — | — | — | — | Disclosed |
| | | | | | | | | | | | steel |
| AH | 21.15 | — | 0.424 | — | — | — | — | — | — | — | Disclosed |
| | | | | | | | | | | | steel |
| AI | 23.00 | 0.552 | — | — | — | — | — | — | — | — | Disclosed |
| | | | | | | | | | | | steel |
| AJ | 22.47 | 0.923 | — | — | — | — | — | — | — | — | Disclosed |
| | | | | | | | | | | | steel |

“—” indicates content at inevitable impurity level.

A steady magnetic field was applied to the CR, GI, or GA steel sheet coil, or to a steel strip uncoiled and fed out from the steel sheet coil. A steady magnetic field having a magnetic flux density listed in Table 2, measured in the vicinity of a magnetic field applying apparatus, was applied for a time listed in Table 2 while maintaining the surface temperature of the steel strip at a temperature listed in Table 2. A typical magnetic field applying apparatus illustrated in FIG. 1 was used as the magnetic field applying apparatus. When a steady magnetic field was applied to a steel sheet coil, the dehydrogenation apparatus illustrated in FIG. 2A to FIG. 2C was used to apply the steady magnetic field to obtain the product coil. When a steady magnetic field was applied to an uncoiled and fed out steel strip, the dehydrogenation apparatus illustrated in FIGS. 3 and 4A was used, and the steel strip was coiled to obtain the product coil after the magnetic field was applied. When a steady magnetic field was applied to a steel sheet coil (outer diameter: 1500 mm, inner diameter: 610 mm, width: 1000 mm), the size of the housing was 2500 mm in the height direction, 2000 mm in the depth direction, and 2500 mm in the width direction, and the magnetic field applying apparatus was disposed on the inner wall of the housing so that the main direction of the steady magnetic field was parallel to the sheet transverse direction of the steel sheet coil. When a steady magnetic field was applied to an uncoiled and fed out steel strip, the magnetic field applying apparatus was disposed on both sides in a rolling surface transverse direction (sheet transverse direction) of the steel strip being passed. Six magnetic field applying apparatus were evenly arranged along the sheet passing direction. The steady magnetic field was arranged so that the main direction of travel of the steady magnetic field was parallel to the sheet transverse direction. Magnetic flux density was adjusted by adjusting the current of the magnetic field applying apparatus. Further, application time was adjusted by adjusting the drive time of the magnetic field applying apparatus for the case where a steady magnetic field was applied to the steel sheet coil. For the case of applying a steady magnetic field to an uncoiled steel strip, application time of the steady magnetic field was adjusted by adjusting sheet passing speed of the steel strip. A tensile property and hydrogen embrittlement resistance of each steel sheet before and after magnetic field application were evaluated by the methods described below, and the results are listed in Table 2.

The tensile property and diffusible hydrogen content in the steel for each steel sheet after magnetic field application were evaluated by the methods described below, and the results are illustrated in Table 2.

Tensile testing was performed in accordance with JIS Z 2241 (2011). From each steel sheet after magnetic field application, a JIS No. 5 test piece was taken so that the tensile direction was perpendicular to the rolling direction of the steel sheet. Each test piece was subjected to a tensile test at a crosshead displacement rate of 1.67×10⁻¹ mm/s to measure tensile strength (TS).

A JIS No. 5 test piece cut from a position halfway along the radial direction of a product coil so that the tensile direction was perpendicular to the rolling direction of the steel sheet was used to conduct a tensile test in accordance with JIS Z 2241 (2011) to measure EL′ (total elongation) after magnetic field application. EL′ was measured within 72 h after the end of annealing. Tensile strength (TS) and EL at 0 mass ppm steel hydrogen content were measured by leaving samples from product coils obtained as described above in air for a long period of time (10 weeks or more) to decrease the steel hydrogen content, and then confirming that the steel hydrogen content had reached 0 mass ppm by TDS as described above before conducting tensile testing. Tensile tests were conducted in accordance with JIS Z 2241 (2011) using JIS No. 5 test pieces taken from steel sheet coils before magnetic field application, and EL″ was measured before magnetic field application.

Hydrogen embrittlement resistance was evaluated from the above tensile tests as follows. When EL′ of a steel sheet after magnetic field application was divided by EL for the same steel sheet having 0 mass ppm steel hydrogen content, hydrogen embrittlement resistance was judged to be good when the value was 0.60 or more.

Further, diffusible hydrogen content in steel before and after magnetic field application was measured by TDS as described above. When measuring diffusible hydrogen content in steel before magnetic field application, a test piece was obtained as described above from a steel sheet coil, not from the product coil, and the diffusible hydrogen content was measured.

Diffusible hydrogen content in steel was measured according to the method described above.

TABLE 2

| | | | | Holding | | | EL″ | TS |
|---|---|---|---|---|---|---|---|---|
| | Steel | Object of | Magnetic | temp. of | Application | | (Before | (0 ppm |
| | sample | magnetic field | flux density | steel sheet | time | | application) | hydrogen) |
| No. | ID | application | (T) | (° C.) | (min) | Type ¹⁾ | (%) | (MPa) |
| 1 | A | Steel | 2.08 | 120 | 600 | GA | 3.5 | 1509 |
| | | sheet | | | | | | |
| | | coil | | | | | | |
| 2 | B | Steel | 1.23 | 180 | 300 | GA | 11.7 | 1007 |
| | | strip | | | | | | |
| 3 | C | Steel | 8.65 | 300 | 1200 | CR | 7.7 | 1006 |
| | | sheet | | | | | | |
| | | coil | | | | | | |
| 4 | D | Steel | 9.38 | 50 | 6000 | GI | 1.3 | 2210 |
| | | sheet | | | | | | |
| | | coil | | | | | | |
| 5 | E | Steel | 2.52 | 250 | 600 | CR | 11.4 | 590 |
| | | strip | | | | | | |
| 6 | F | Steel | 11.42 | 220 | 3600 | CR | 6.3 | 1039 |
| | | strip | | | | | | |
| 7 | G | Steel | 12.20 | 140 | 12000 | GI | 2.9 | 1823 |
| | | sheet | | | | | | |
| | | coil | | | | | | |
| 8 | H | Steel | 13.20 | 260 | 5400 | GA | 4.1 | 1183 |
| | | sheet | | | | | | |
| | | coil | | | | | | |
| 9 | I | Steel | 14.50 | 200 | 24000 | GI | 4.6 | 1522 |
| | | strip | | | | | | |
| 10 | J | Steel | 6.90 | 240 | 12000 | GA | 9.7 | 1013 |
| | | strip | | | | | | |
| 11 | K | Steel | 1.44 | 100 | 600 | GI | 29.0 | 1039 |
| | | sheet | | | | | | |
| | | coil | | | | | | |
| 12 | L | Steel | 5.54 | 160 | 1200 | GA | 5.1 | 990 |
| | | strip | | | | | | |
| 13 | M | Steel | 2.86 | 110 | 900 | CR | 5.8 | 789 |
| | | strip | | | | | | |
| 14 | N | Steel | 1.38 | 120 | 600 | GI | 7.1 | 1329 |
| | | strip | | | | | | |
| 15 | O | Steel | 4.93 | 190 | 12000 | GI | 8.5 | 908 |
| | | strip | | | | | | |
| 16 | P | Steel | 2.88 | 100 | 1200 | GA | 3.9 | 1275 |
| | | sheet | | | | | | |
| | | coil | | | | | | |
| 17 | Q | Steel | 4.85 | 140 | 1200 | GI | 6.3 | 931 |
| | | sheet | | | | | | |
| | | coil | | | | | | |
| 18 | R | Steel | 0.87 | 50 | 600 | CR | 6.6 | 1161 |
| | | sheet | | | | | | |
| | | coil | | | | | | |
| 19 | S | Steel | 0.14 | 80 | 120 | GA | 7.3 | 1488 |
| | | strip | | | | | | |
| 20 | T | Steel | 1.45 | 200 | 20 | GI | 11.6 | 1009 |
| | | sheet | | | | | | |
| | | coil | | | | | | |
| 21 | U | Steel | 0.46 | 80 | 300 | GA | 4.7 | 1336 |
| | | strip | | | | | | |
| 22 | V | Steel | 2.19 | 190 | 600 | GA | 5.7 | 1311 |
| | | strip | | | | | | |
| 23 | W | Steel | 0.36 | 230 | 60 | GA | 8.0 | 1218 |
| | | sheet | | | | | | |
| | | coil | | | | | | |
| 24 | X | Steel | 11.90 | 220 | 6000 | GI | 3.4 | 1476 |
| | | strip | | | | | | |
| 25 | Y | Steel | 0.26 | 150 | 60 | GA | 4.0 | 1537 |
| | | sheet | | | | | | |
| | | coil | | | | | | |
| 26 | Z | Steel | 8.31 | 240 | 1200 | CR | 3.3 | 1041 |
| | | strip | | | | | | |
| 27 | AA | Steel | 4.54 | 70 | 3000 | GA | 6.0 | 1555 |
| | | strip | | | | | | |
| 28 | AB | Steel | 1.44 | 200 | 300 | CR | 12.6 | 1019 |
| | | sheet | | | | | | |
| | | coil | | | | | | |
| 29 | AC | Steel | 0.30 | 210 | 120 | GI | 5.5 | 1337 |
| | | strip | | | | | | |
| 30 | AD | Steel | 0.21 | 260 | 15 | GA | 6.5 | 1324 |
| | | sheet | | | | | | |
| | | coil | | | | | | |
| 31 | AE | Steel | 1.38 | 80 | 600 | CR | 11.9 | 627 |
| | | strip | | | | | | |
| 32 | AF | Steel | 1.30 | 150 | 300 | CR | 8.1 | 613 |
| | | strip | | | | | | |
| 33 | AG | Steel | 0.56 | 130 | 150 | CR | 5.9 | 606 |
| | | sheet | | | | | | |
| | | coil | | | | | | |
| 34 | AH | Steel | 13.00 | 200 | 7200 | CR | 5.6 | 595 |
| | | strip | | | | | | |
| 35 | AI | Steel | 5.97 | 230 | 900 | CR | 8.4 | 596 |
| | | strip | | | | | | |
| 36 | AJ | Steel | 8.65 | 100 | 3600 | CR | 6.2 | 596 |
| | | sheet | | | | | | |
| | | coil | | | | | | |
| 37 | A | Steel | 0.004 | 30 | 3600 | CR | 4.4 | 1517 |
| | | strip | | | | | | |
| 38 | A | Steel | 1.30 | −5 | 2400 | GA | 9.8 | 1565 |
| | | strip | | | | | | |
| 39 | A | Steel | 0.73 | 420 | 60 | GA | 21.3 | 591 |
| | | strip | | | | | | |
| 40 | A | Steel | 14.90 | 120 | 300 | GA | 3.9 | 1612 |
| | | sheet | | | | | | |
| | | coil | | | | | | |
| 41 | A | Steel | 0.53 | 260 | 180 | GI | 3.7 | 1503 |
| | | strip | | | | | | |
| 42 | A | Steel | 0.14 | 60 | 300 | GA | 4.0 | 1495 |
| | | strip | | | | | | |
| 43 | A | Steel | 8.45 | 220 | 0.5 | GA | 9.3 | 1490 |
| | | sheet | | | | | | |
| | | coil | | | | | | |
| 44 | A | Steel | 2.45 | 150 | 28000 | GI | 2.0 | 1587 |
| | | strip | | | | | | |

| | | | | Diffusible | Diffusible | |
|---|---|---|---|---|---|---|
| | | | | hydrogen content | hydrogen content | |
| | EL | EL′ | Hydrogen | in steel | in steel | |
| | (0 ppm | (After | embrittlement | (Before | (After | |
| | hydrogen) | application) | resistance | application) | application) | |
| No. | (%) | (%) | EL′/EL | (mass ppm) | (mass ppm) | Remarks |
| 1 | 9.5 | 9.4 | 0.99 | 0.61 | 0.10 | Example |
| 2 | 24.9 | 22.4 | 0.90 | 0.99 | 0.32 | Example |
| 3 | 26.0 | 24.1 | 0.93 | 0.84 | 0.11 | Example |
| 4 | 5.9 | 5.8 | 0.98 | 1.81 | 0.02 | Example |
| 5 | 25.9 | 21.2 | 0.82 | 0.58 | 0.19 | Example |
| 6 | 14.0 | 10.8 | 0.77 | 1.02 | 0.38 | Example |
| 7 | 8.2 | 5.7 | 0.70 | 1.43 | 0.42 | Example |
| 8 | 10.3 | 9.4 | 0.91 | 0.62 | 0.16 | Example |
| 9 | 21.1 | 21.0 | 1.00 | 0.99 | 0.01 | Example |
| 10 | 23.0 | 21.0 | 0.91 | 0.66 | 0.16 | Example |
| 11 | 45.2 | 33.4 | 0.74 | 0.58 | 0.45 | Example |
| 12 | 18.9 | 18.0 | 0.95 | 0.62 | 0.06 | Example |
| 13 | 24.0 | 23.8 | 0.99 | 0.73 | 0.03 | Example |
| 14 | 12.5 | 11.1 | 0.89 | 0.74 | 0.32 | Example |
| 15 | 24.8 | 20.1 | 0.81 | 1.21 | 0.27 | Example |
| 16 | 12.9 | 12.5 | 0.97 | 0.84 | 0.08 | Example |
| 17 | 29.7 | 28.0 | 0.94 | 0.79 | 0.03 | Example |
| 18 | 13.7 | 12.4 | 0.91 | 0.51 | 0.17 | Example |
| 19 | 12.5 | 10.5 | 0.84 | 0.72 | 0.36 | Example |
| 20 | 18.6 | 14.0 | 0.75 | 0.68 | 0.48 | Example |
| 21 | 12.8 | 12.0 | 0.94 | 0.81 | 0.17 | Example |
| 22 | 13.1 | 10.7 | 0.82 | 0.99 | 0.32 | Example |
| 23 | 16.9 | 14.9 | 0.88 | 0.57 | 0.20 | Example |
| 24 | 10.0 | 9.3 | 0.93 | 1.00 | 0.15 | Example |
| 25 | 12.6 | 12.0 | 0.95 | 0.52 | 0.08 | Example |
| 26 | 14.7 | 13.7 | 0.93 | 1.01 | 0.05 | Example |
| 27 | 16.4 | 15.0 | 0.91 | 0.72 | 0.15 | Example |
| 28 | 27.9 | 22.9 | 0.82 | 0.58 | 0.19 | Example |
| 29 | 15.0 | 13.9 | 0.93 | 0.51 | 0.09 | Example |
| 30 | 14.2 | 13.1 | 0.92 | 0.50 | 0.15 | Example |
| 31 | 48.4 | 48.3 | 1.00 | 0.65 | 0.02 | Example |
| 32 | 28.2 | 28.0 | 0.99 | 0.56 | 0.05 | Example |
| 33 | 22.4 | 21.7 | 0.97 | 0.55 | 0.03 | Example |
| 34 | 24.4 | 24.0 | 0.98 | 0.59 | 0.02 | Example |
| 35 | 23.6 | 21.7 | 0.92 | 0.54 | 0.11 | Example |
| 36 | 21.3 | 19.9 | 0.93 | 0.55 | 0.07 | Example |
| 37 | 10.9 | 4.3 | 0.39 | 0.66 | 0.66 | Comparative |
| | | | | | | Example |
| 38 | 14.1 | 10.8 | 0.77 | 0.82 | 0.50 | Example |
| 39 | 25.2 | 25.1 | 1.00 | 0.77 | 0.02 | Example |
| 40 | 8.6 | 7.1 | 0.83 | 0.58 | 0.19 | Example |
| 41 | 13.3 | 12.8 | 0.96 | 0.58 | 0.04 | Example |
| 42 | 14.5 | 14.5 | 1.00 | 0.57 | 0.03 | Example |
| 43 | 15.4 | 10.2 | 0.66 | 0.70 | 0.50 | Example |
| 44 | 9.9 | 9.6 | 0.97 | 2.02 | 0.02 | Example |

Underlined: indicates outside scope of present disclosure.
¹⁾ CR: cold-rolled steel sheet, GI: hot-dip galvanized steel sheet (without alloying treatment of galvanized coating), GA: galvannealed steel sheet

According to the Examples, a steady magnetic field was applied to the steel sheets, which resulted in production of steel sheets having excellent hydrogen embrittlement resistance.

### REFERENCE SIGNS LIST

60 magnetic field applying apparatus
60A electromagnet (magnetic field applying apparatus)
60B electromagnet (magnetic field applying apparatus)
62A iron core
62B iron core
64A coil
64B coil
66A magnetic pole face (N pole)
66B magnetic pole face (S pole)
74 heating apparatus
80 housing
90 coil holder
300a dehydrogenation apparatus
300b dehydrogenation apparatus
S steel strip
C steel sheet coil

1. A dehydrogenation apparatus comprising:
a housing configured to accommodate a steel sheet coil obtained by coiling a steel strip; and
a magnetic field applying apparatus configured to apply a steady magnetic field along the sheet transverse direction of the steel sheet coil in the housing.

2. The dehydrogenation apparatus according to claim 1, wherein the magnetic field applying apparatus comprises an electromagnet disposed outside a sheet transverse direction edge of the steel sheet coil, and the electromagnet has a magnetic pole face facing a sheet transverse direction end surface of the steel sheet coil.

3. The dehydrogenation apparatus according to claim 1, wherein the magnetic field applying apparatus comprises a pair of electromagnets disposed outside sheet transverse direction edges of the steel sheet coil, and each electromagnet of the pair of electromagnets has a magnetic pole face facing a sheet transverse direction end surface of the steel sheet coil, and one of the magnetic pole faces is an N pole and the other is an S pole.

4. The dehydrogenation apparatus according to claim 1, wherein the magnetic field applying apparatus is set so that magnetic flux density in the sheet transverse direction of the steel sheet coil is 0.1 T to 15 T.

5. The dehydrogenation apparatus according to claim 1, further comprising a heater configured to heat the steel sheet coil while the steady magnetic field is being applied.

6. A dehydrogenation apparatus comprising:
a payoff apparatus configured to uncoil a steel sheet coil to feed a steel strip;
a sheet passing apparatus configured to pass the steel strip therethrough;
a coiling apparatus configured to coil the steel strip;
a magnetic field applying apparatus configured to apply a steady magnetic field along the sheet transverse direction of the steel strip to the steel strip being passed through the sheet passing apparatus.

7. The dehydrogenation apparatus according to claim 6, wherein the magnetic field applying apparatus comprises an electromagnet disposed outside a sheet transverse direction edge of the steel strip, and the electromagnet has a magnetic pole face facing a sheet transverse direction edge surface of the steel strip.

8. The dehydrogenation apparatus according to claim 6, wherein the magnetic field applying apparatus comprises a pair of electromagnets disposed outside sheet transverse direction edges of the steel strip, and each electromagnet of the pair of electromagnets has a magnetic pole face facing a sheet transverse direction edge surface of the steel strip, and one of the magnetic pole faces is an N pole and the other is an S pole.

9. The dehydrogenation apparatus according to claim 6, wherein the magnetic field applying apparatus is set so that magnetic flux density in the sheet transverse direction of the steel strip is 0.1 T to 15 T.

10. The dehydrogenation apparatus according to claim 6, further comprising a heater configured to heat the steel strip while the steady magnetic field is being applied.

11. The dehydrogenation apparatus according to claim 1, further comprising a magnetic field blocker configured to prevent transmission of the steady magnetic field to outside of the dehydrogenation apparatus.

12-15. (canceled)

16. A steel sheet production system comprising:
a coating or plating apparatus configured to form a coating or plating on a surface of a hot-rolled steel sheet or a cold-rolled steel sheet to obtain a coated or plated steel sheet;
a coated or plated steel sheet coiling apparatus configured to coil the coated or plated steel sheet to obtain a coated or plated steel sheet coil; and
the dehydrogenation apparatus according to claim 1, wherein the coated or plated steel sheet coil is the steel sheet coil.

17-19. (canceled)

20. A method of producing a steel sheet, the method comprising:
a magnetic field applying process of applying a steady magnetic field to a steel sheet coil obtained by coiling a steel strip, along the sheet transverse direction of the steel sheet coil, to obtain a product coil.

21. The method of producing a steel sheet according to claim 20, wherein magnetic flux density in the sheet transverse direction of the steel sheet coil is 0.1 T to 15 T in the magnetic field applying process.

22. The method of producing a steel sheet according to claim 20, wherein the magnetic field applying process is performed while holding the steel sheet coil at 300° C. or less.

23. A method of producing a steel sheet, the method comprising:
a process of uncoiling a steel sheet coil to feed a steel strip;
a sheet passing process of passing the steel strip; and
a process of coiling the steel strip to obtain a product coil,
wherein the sheet passing process includes a magnetic field applying process of applying a steady magnetic field to the steel strip along the sheet transverse direction of the steel strip.

24. The method of producing a steel sheet according to claim 23, wherein magnetic flux density in the sheet transverse direction of the steel strip is 0.1 T to 15 T in the magnetic field applying process.

25. The method of producing a steel sheet according to claim 23, wherein the magnetic field applying process is performed while holding the steel strip at 300° C. or less.

26-29. (canceled)

30. The method of producing a steel sheet according to claim 20, the method further comprising:
a coating or plating process of forming a coating or plating on a surface of a hot-rolled steel sheet or a cold-rolled steel sheet to obtain a coated or plated steel sheet; and
a process of coiling the coated or plated steel sheet to obtain a coated or plated steel sheet coil,
wherein the coated or plated steel sheet coil is the steel sheet coil.

31-33. (canceled)

34. The method of producing a steel sheet according to claim 20, wherein the product coil comprises a high strength steel sheet having a tensile strength of 590 MPa or more.

35. The method of producing a steel sheet according to claim 20, wherein the product coil comprises a base steel sheet having a chemical composition containing, in mass %,
C: 0.030% or more and 0.800% or less,
Si: 0.01% or more and 3.00% or less,
Mn: 0.01% or more and 10.00% or less,
P: 0.001% or more and 0.100% or less,
S: 0.0001% or more and 0.0200% or less,
N: 0.0005% or more and 0.0100% or less, and
Al: 2.000% or less,
optionally at least one element selected from the group consisting of
Ti: 0.200% or less,
Nb: 0.200% or less,
V: 0.500% or less,
W: 0.500% or less,
B: 0.0050% or less,
Ni: 1.000% or less,
Cr: 1.000% or less,
Mo: 1.000% or less,
Cu: 1.000% or less,
Sn: 0.200% or less,
Sb: 0.200% or less,
Ta: 0.100% or less,
Ca: 0.0050% or less,
Mg: 0.0050% or less,
Zr: 0.0050% or less, and
REM: 0.0050% or less,
with the balance being Fe and inevitable impurity.

36-38. (canceled)

39. The method of producing a steel sheet according to claim 20, wherein the product coil has a diffusible hydrogen content of 0.50 mass ppm or less.
